(19) United States
(12) Patent Application Publication
(10) Pub. No.: US 2016/0379520 A1
(43) Pub. Date: Dec. 29, 2016

(54) NUTRIENT DENSITY DETERMINATIONS TO SELECT HEALTH PROMOTING CONSUMABLES AND TO PREDICT CONSUMABLE RECOMMENDATIONS

(71) Applicants: Laura Borel, Menlo Park, CA (US); Monica Rogati, Sunnyvale, CA (US); Christian Middleton, San Francisco, CA (US); Emi Nomura, San Francisco, CA (US); Max Everett Utter, II, San Francisco, CA (US)

(72) Inventors: Laura Borel, Menlo Park, CA (US); Monica Rogati, Sunnyvale, CA (US); Christian Middleton, San Francisco, CA (US); Emi Nomura, San Francisco, CA (US); Max Everett Utter, II, San Francisco, CA (US)

(73) Assignee: AliphCom, San Francisco, CA (US)

(21) Appl. No.: 14/749,622

(22) Filed: Jun. 24, 2015

(51) Int. Cl. G09B 19/00; G09B 5/02

(52) U.S. Cl. CPC G09B 19/0092; G09B 5/02

(57) ABSTRACT

Various embodiments relate generally to electrical and electronic hardware, computer software, wired and wireless network communications, and wearable computing and audio devices for monitoring and managing health and wellness. More specifically, disclosed are methods, interfaces, and computer-readable media to generate predictive consumable recommendations and indicators to determine nutrient density of health-promoting nutrients in consumables, such as food, drink, supplements, and the like. In one or more embodiments, a flow includes identifying nutritional content of one or more consumables, selecting a first element of the one or more consumables, identifying the first element as a first nutrient, and identifying a second element of the one or more consumables. Further, the flow includes characterizing an association between the first nutrient and the second element, and determining an indicator indicative of a nutrient density of at least the first element included in the one or more consumables. In one example, the indicator includes a food score.

### CROSS-REFERENCE TO RELATED APPLICATIONS

This application claims the benefit of U.S. Provisional Patent Application No. 62/016,551, filed Jun. 24, 2014, which is herein incorporated by reference for all purposes.

### FIELD

Various embodiments relate generally to electrical and electronic hardware, computer software, wired and wireless network communications, and wearable computing and audio devices for monitoring and managing health and wellness. More specifically, disclosed are methods, interfaces, and computer-readable media to generate predictive consumable recommendations and indicators (e.g., food scores) to determine nutrient density of health-promoting consumables, such as health-promoting nutrients in consumables including food, drink, supplements, and the like.

### BACKGROUND

Conventional techniques for assessing nutritional qualities of a food item and for recommending food items for consumption typically require a person to understand the complexities of nutrition science. Further, the various formats of nutrition labels usually organizes nutritional information in a manner that confuses a reader as to whether a certain food item is sufficient to meet one's nutritional and health-related goals. It is not uncommon for a nutrition label to recite more than 15 numbers for which the reader needs to comprehend to readily assess the nutritional value of a food product. Such nutrition labels and other traditional techniques for conveying nutrition information are not well-suited to enable the reader to compare the nutritional benefits of one product against another product. Further, traditional food logging devices typically are calorie-centric; that is, known food logging techniques principally track calories, with nutritional-related information being tracked secondarily.

Thus, what is needed is a solution for conveying nutritional information effectively without the limitations of conventional techniques.

### BRIEF DESCRIPTION OF THE DRAWINGS

Various embodiments or examples (“examples”) of the invention are disclosed in the following detailed description and the accompanying drawings:

FIG. 1 is a functional block diagram depicting a nutrition intake evaluator configured to generate an indicator representing nutrition density of a consumable, according to some embodiments;

FIG. 2 is a diagram depicting a display of an indicator value, according to some embodiments;

FIG. 3 is a diagram depicting a display of indicator values during search for a meal, according to some embodiments;

FIG. 4 is a diagram depicting a nutrition density indicator generator, according to some embodiments;

FIG. 5 is a diagram depicting operation of a nutrient association characterizer, according to some embodiments;

FIGS. 6A, 6B, 6C, and 6D are examples of graphical relationships to determine intermediate scores, according to some embodiments;

FIG. 7 is a diagram depicting additional functionality of a nutrient association characterizer, according to some embodiments;

FIGS. 8A and 8B are examples of graphical relationships to determine intermediate scores, according to some embodiments;

FIG. 9 depicts an indicator calculator configured to generate an indicator, according to some embodiments;

FIG. 10 is a diagram depicting another example of a nutrient association characterizer, according to some embodiments;

FIGS. 11A, 11B, 11C, 11D, 11E, and 11F are examples of graphical relationships that can be used to determine intermediate scores based on a magnitude, according to some embodiments;

FIG. 12 is a diagram depicting yet another example of a nutrient association characterizer, according to some embodiments;

FIGS. 13A, 13B, 13C, 13D, and 13E are examples of graphical relationships that can be used to determine intermediate scores based on a magnitude, according to some embodiments;

FIGS. 14A and 14B depict examples of indicator calculators configured to generate an indicator, according to some embodiments;

FIG. 15 is an example of a flow diagram to calculate an indicator of a density of nutrients for consumable items, according to some embodiments;

FIG. 16 is a diagram depicting a recommendation engine, according to some examples;

FIG. 17 is a diagram depicting a nutrition density correlator, according to some embodiments;

FIG. 18 is a diagram depicting a dynamic meal plan manager, according to some embodiments;

FIGS. 19A to 19D are diagrams depicting examples of operation of a dynamic meal plan manager, according to various embodiments;

FIG. 20 is a diagram depicting a consumable item selection predictor, according to some embodiments;

FIG. 21 is a diagram of relationships among likely selections of food items, according to some embodiments;

FIG. 22 is a diagram depicting presentation of inferred food items for selection during food logging, according to some embodiments; and

FIG. 23 illustrates an exemplary computing platform disposed in a device configured to provide food-related tracking in accordance with various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

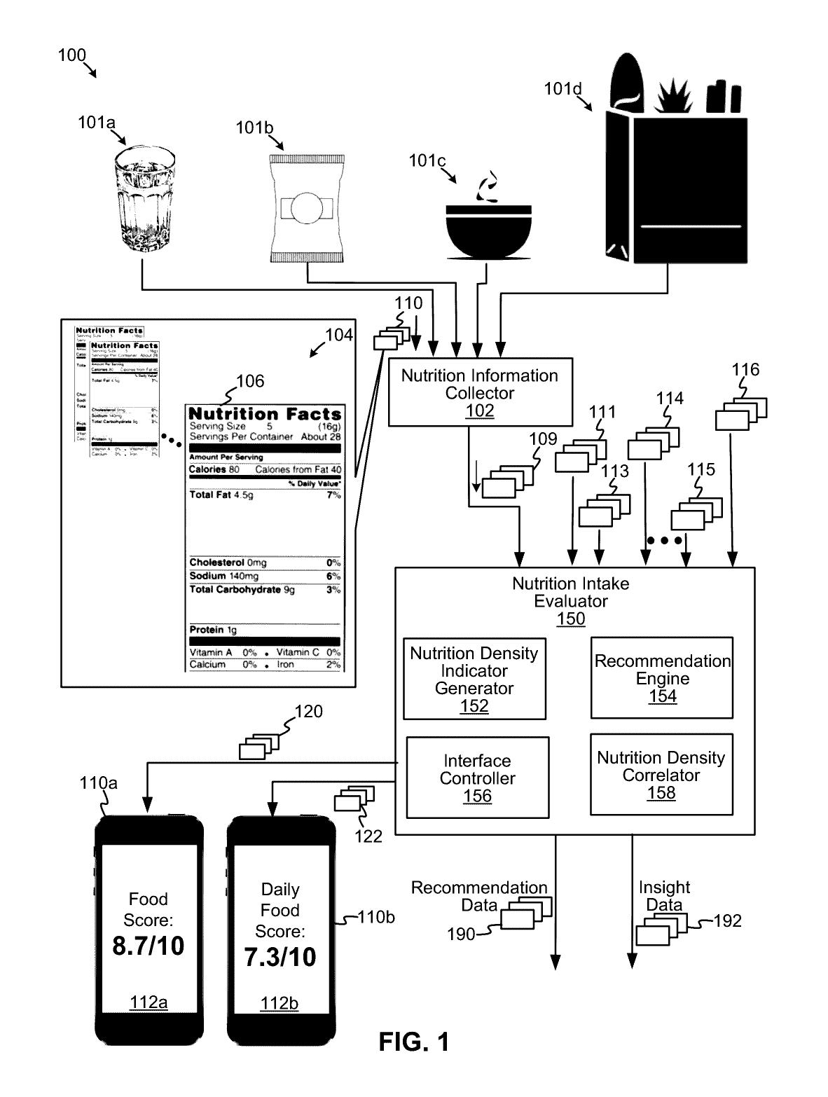

FIG. 1 is a functional block diagram depicting a nutrition intake evaluator configured to generate an indicator representing nutrition density of a consumable, according to some embodiments. Diagram 100 depicts a nutrition intake evaluator 150 that is configured to receive data 109 representing nutrition information associated with, or related to, one or more of consumables 101a, 101b, 101c, and 101d, and is further configured to generate data representing an indicator, for example, having one or more values representative of a nutrition density of one or more consumables or consumable items. In some examples, the nutrition density specifies that a consumable may have optimal relative amounts of macro and/or micro nutrients, such as optimal relative amounts of health-promoting nutrients and health-impairing nutrients. For example, various criteria may specify certain amounts of nutrients or components of consumables to promote health of a user based on the user's condition, state, and/or nutritional goals or needs. Further to diagram 100, nutrition intake evaluator 150 can generate data 120 representing an indicator for one or more consumables (e.g., a prospective meal that a user is considering, or one or more other food items, etc.). As shown, a device 110a includes a display or interface 112a for displaying the indicator as a “food score” of 8.7/10. Also, nutrition intake evaluator 150 can generate data 122 that represents an indicator composed of aggregated indicators (e.g., one or more food scores for multiple meals may or may not be aggregated, combined, summarized, condensed, etc.) for consumables that are consumed over multiple units of time (e.g., over the course of a day, week, or any other time period). As shown, a device 110b includes a display or interface 112b for displaying the indicator as a “daily food score” of 7.3/10, which may be configured as a digest representing, or otherwise specifying, a relative nutrition density to describe, for example, a combination of meals consumed over the course of a day.

In view of the foregoing, the structures and/or functionalities of nutrition intake evaluator 150, which may be implemented in hardware, software, or a combination thereof, as described herein, can facilitate communication to a user of a relative degree of healthiness of a dish, a meal, or food item. In accordance with various embodiments, an indicator (e.g., a “food score”) is an efficient or compressed representation indicative of the health-related qualities of a consumable item, and enables a user to determine the impact of a food item on their health with little to negligible effort (e.g., “at a glance”). In some cases, an indicator of the various embodiments can provide a non-calorie metric for comparing the nutritional benefits of different consumable items, and need not require a quantity or an amount of a food item to determine an indicator. Thus, an indicator can convey, for example, an optimal (e.g., highest) ratio of healthy nutrients (e.g., naturally-occurring foods) to unhealthy nutrients (e.g., processed foods) independent of a quantity or weight of consumable items, according to some examples. In at least one example, the use of indicators described herein enables a user to determine a degree of healthy eating even though one or more meals may not be logged over the course of one or more days. Moreover, the use of an indicator, as a metric, facilitates a comparison among meal choices when a user desires to select a healthy choice.

As shown in FIG. 1, a nutrition information collector 102 is configured to receive data 110 representing nutritional information 104 (e.g., integrated or aggregated nutrition information), which can include nutritional information 106 for one or more consumables 101a to 101d. A consumable or consumable item, for example, as described herein, can refer to any item of food, drink, supplement, ingredient, vitamin, or any material that can be ingested that may impact a health of a user. A consumable item may include health-promoting nutrients as well health-impairing nutrients. For example, consumable 101a can be a food item (or drink item) composed of a single ingredient, such as water, and consumable 101b can be a food item composed of one type of food (e.g., baked potato chips) that includes multiple ingredients. Consumable 101c can represent a meal including multiple food items. Consumable 101d represents a number of groceries or multiple food items for creating multiple meals. Any of these consumables can be purchased as a pre-made meal, delivered from a restaurant, created by way of recipe, or the like. Data 110 may be received from a variety of sources, such as manual entry by a user, by scanning barcodes optically on consumable packaging, from a networked computing device and/or database, etc.

Nutrition intake evaluator 150 includes a nutrition density indicator generator 152, a recommendation engine 154, an interface controller 156, and a nutrition density correlator 158. Further, nutrition intake evaluator 150 is also configured to receive state data 111, conditional data 113, goal data 114, other data 115, and weighting data 116, and the like. State data 111 includes any type of data describing an active state of the user (e.g., a type of activity in which user is engaged, such as walking, running, sitting, etc., the intensity of engaging in such an activity, durations of such activities, times of day in which an activity typically occurs, physiological characteristics, such as heart rate, associated in an activity, rate of caloric burn, amount of calories expended, hydration levels, and the like). State data 111 also includes sleep-related data, such as data representing the quality of sleep (e.g., sufficiency of REM sleep, etc.), the quantity of sleep, and other sleep-related durations of sleep, times of day in which sleep typically occurs, physiological characteristics, such as heart rate, associated with sleep, and the like. Further, state data 111 can also include mood-related data that describes an emotional or affective state of the user (e.g., whether a user is content, stressed, lethargic, happy, angry, upset, depressed, etc.) during any time period, including over multiple units of time (e.g., multiple days).

Condition data 113 includes data describing one or more conditions of a person. For example, condition data 113 can describe whether a user is suffering from a disease (e.g., chronic or otherwise), such as hypertension, heart disease, arthritis, cancer, diabetes, asthma, etc., or whether the user has an injury. Condition data 113 also can describe food allergies, such as to gluten, nuts, shell fish, dairy, etc., or a propensity (or lack thereof) to consume a food item. Condition data 113 also includes data describing whether a woman is pregnant, or a person has a cold or the flu, or the like. Goal data 114 includes data describing one or more goals, such as a number of steps per day, an amount of sleep per night, weight-loss goals, rate of weight loss, fitness goals, selective eating goals (e.g., eating certain foods with a certain nutrient for addressing a certain ailment), and the like. Other data 115 includes data describes other information that may be usable with, or to form, an indicator value or food score. Data 115 can also include data that describes biometric information, such as an age, a gender, a height, a weight, a body type, a BMI, etc. Weighting data 116 includes weight values for application against intermediate, individual, or subsets of scores or any type of score based on, for example, a type of nutrient being evaluated. A food item including trans fats (e.g., trans-unsaturated fatty acids, etc.) may be associated with a food score that is weighted to indicate the health-impairing effects such as nutrient.

Nutrition density indicator generator 152 is configured to generate at least an indicator based on nutrition data 109. In some cases, the generation of the indicator can be influenced based on other data, such as state data 111, conditional data 113, goal data 114, other data 115, and/or weighting data 116. In some embodiments, nutrition density indicator generator 152 is configured to generate, for example, a weighted average of a number of intermediate scores derived from evaluating a number of nutrients in association with other nutrients or consumable characteristics (e.g., per number of calories, such as per 100 calories, or any other food-related characteristic). In some cases, nutrition density indicator generator 152 can apply different weighting values from weighting data 116 to solicit or promote an increase in a particular nutrient. For example, during cold and flu season, weighting data 116 can weight food items including vitamin C more heavily than the spring and summer seasons. As another example, nutrition density indicator generator 152 can customize determination of a value of an indicator as a function of a person's nutritional needs based on age and gender.

Recommendation engine 154 is configured to generate data 190 representing one or more recommended consumable items that are substantially similar to a requested consumable item, whereby the recommended consumable items may have higher indicator values (e.g., higher food scores), which, in turn, indicate that at least a recommended consumable item may be more healthier than a user-requested consumable item. For example, consider that a user is searching for a breakfast cereal that is sweetened artificially (e.g., having food score of 6.6). Recommendation engine 154 is configured to search for other breakfast cereals that are similar to the searched breakfast cereal (e.g., similar in taste, based on ingredients, consumer reviews, etc.) and to present at least on other breakfast cereal that has a higher food score (e.g., 7.2).

Nutrition density correlator 158 is configured to correlate a food score to other information, such as state data 111 (e.g., a user's mood, activity level, quality of sleep, etc.), conditional data 113, goal data 114, other data 115, and/or weighting data 116, and to generate informational “insight” data 192 as either observations, notifications, or recommended courses of action. Nutrition density correlator 158 can also generate data describing trends between a user's food score over time against other data. For example, one set of trend data can depict a relationship between higher daily food scores and longer durations in which a user performs an activity (e.g., more laps at a swimming pool). In some examples, nutrition density correlator 158 is configured to track and correlate food scores to daily activity, sleep, and mood so that nutrition density indicator generator 152 can adapt a food scoring determination process based on one or more of a daily activity, sleep, mood, etc.

Interface controller 156 is configured to receive data generated by other elements of nutrition intake evaluator 150 for generating signals to present an indicator value to interfaces 112a and 112b. Further, interface controller 156 can be configured to receive signals indicating a food-related requests, whereby an indicator value or food score for a prospective meal can be determined and presented via an interface. As such, interface controller 156 is configured to graphically convey to a user (e.g., in a formatted arrangement as stored in a databased and/or displayed visually to a user) an optimal food or drink choice based on, for example, a compress representation of a degree of healthiness which is accessible to a user. In various embodiments, nutrition intake evaluator 150 may generate data arrangements configured to effectuate efficient nutrition-related selections for urging a user to effectively consume optimally calculated ingredients and/or nutrients.

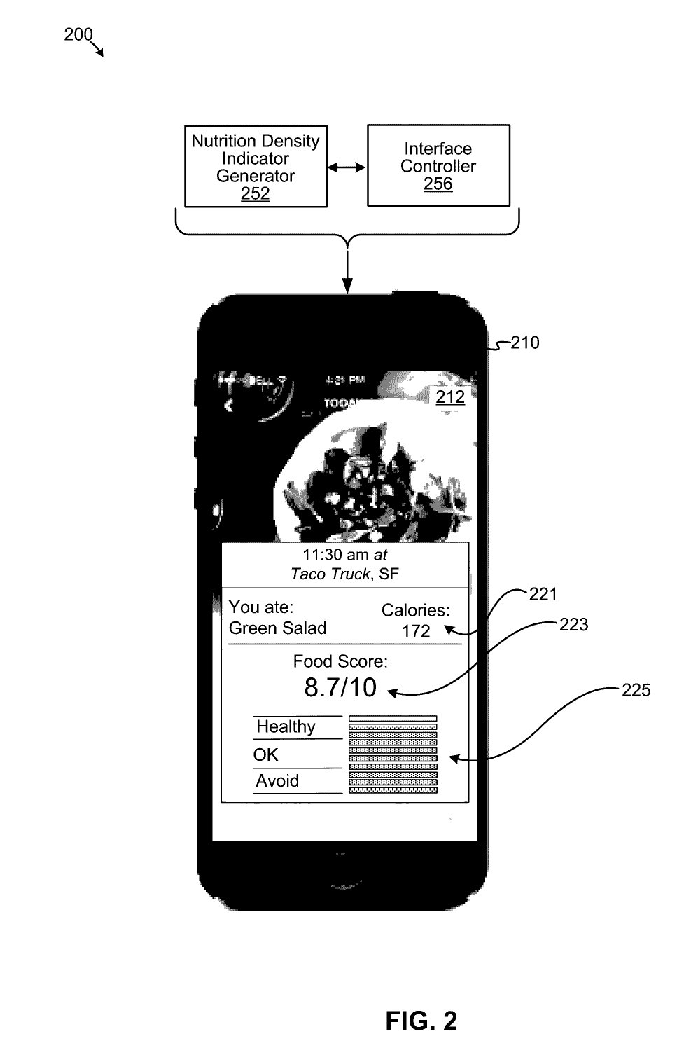

FIG. 2 is a diagram depicting a display of an indicator value, according to some embodiments. Diagram 200 depicts a nutrition density indicator generator 252 functioning cooperatively with an interface controller 256 to generate a signal to cause presentation of an indicator value (e.g., a food score) at an interface 212 of mobile computing device 210. As shown, a portion 221 of interface 212 is displaying a type of food item (either consumed or prospectively consumed), such as a “green salad.” An indicator value of 8.7 is displayed in a portion 223 of interface 212. Note, too, that an indicator is depicted in graphical form in a portion 225 of interface 212. In particular, ten (10) graduated indicator bars, each representing one of ten points, can be illuminated corresponding to the indicator value. That is, 8 and 7/10 bars can be illuminated for a food score of 8.7. In some examples, colors can also convey an approximate indicator value. For example, food items above or equal to eight (8) are viewed as “healthy” and are associated with a green color, whereas food items having food scores between six (6) and eight (8) are viewed as “OK” and can be associated with an orange color. A food item having a food score below six (6) are associated with a red color and are considered foods that ought to be avoided.

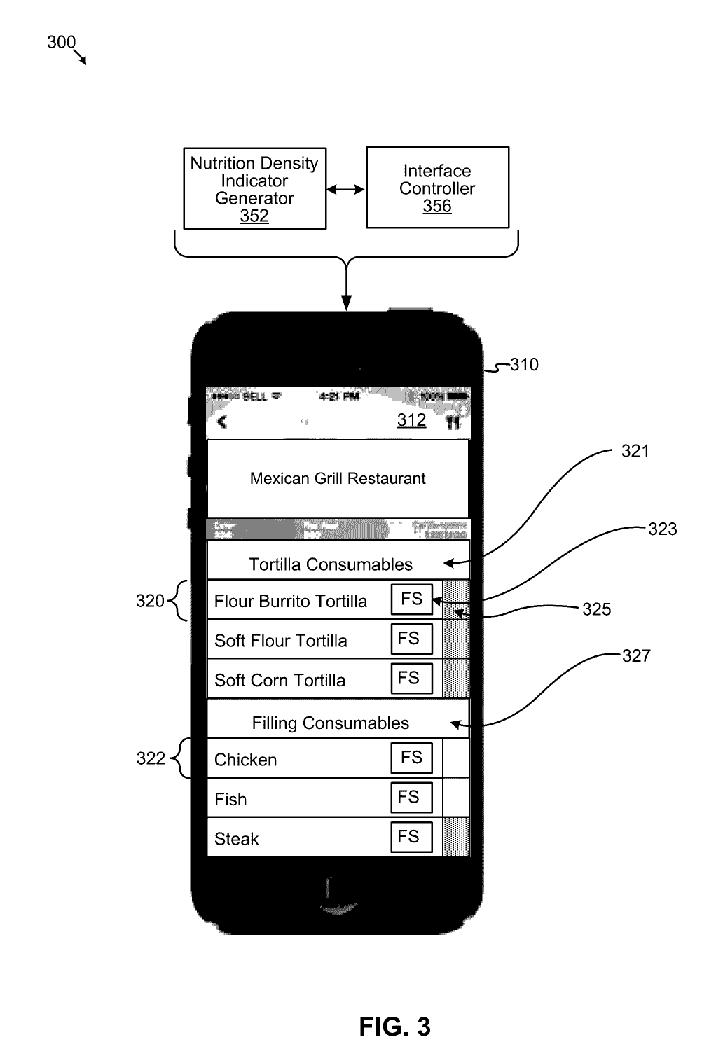

FIG. 3 is a diagram depicting a display of indicator values during a search for a meal, according to some embodiments. Diagram 300 depicts a nutrition density indicator generator 352 functioning cooperatively with an interface controller 356 to generate a signal to cause presentation of consumable items and associated indicator values (e.g., food scores) at an interface 312 of mobile computing device 310. As shown, a portion 321 of interface 312 is displaying a category of a food item (either consumed or prospectively consumed), such as a “tortilla.” In portions 320 of interface 312, different types of tortillas are displayed with a corresponding food score (“FS”) 323 (e.g., as an intermediate score) and an indicator color 325 indicative of a degree of “healthiness.” Portion 327 of interface 312 depicts a category of another food item, such as a “filling” to be placed in a selected tortilla. Portions 322 display different types of fillings and accompanying food scores, “FS,” (e.g., as an intermediate score). Once a tortilla and a filling are selected, another food score can be determined for a meal based on a combination of nutrients from a number of individual food items.

FIG. 4 is a diagram depicting a nutrition density indicator generator, according to some embodiments. Diagram 400 illustrates a nutrition density indicator generator 452 configured to receive nutrition data 401, and to generate indicator data 490 representing nutrient density for one or more consumable items constituting, for example, one or more meals. In the example shown, nutrition density indicator generator 452 includes a nutrient evaluator 402, a nutrient association characterizer 404, a characterized association valuator 406, a weighing value unit 408, a nutrient-based modifier 410, and an indicator calculator 420.

Nutrient evaluator 402, which is optional in some instances, is configured to determine whether a consumable item includes threshold amounts of nutrients and/or associated nutrition information to sufficiently form an effective indicator or intermediate indicator (e.g., an effective food score or intermediate food score). In one example, nutrient evaluator 402 can be configured to enable the scoring of a consumable item if a consumable item includes a total number of carbohydrates, an amount of sugar, an amount of fiber, an amount of protein, and at least two or more of: (1.) a total amount of fat, (2.) an amount of saturated fat, and (3.) an amount of unsaturated fat. In at least one case, nutrient evaluator 102 enables scoring if an amount of calories is non-zero. According to various embodiments, more or fewer of the aforementioned nutrient requirements may be implemented by nutrient evaluator 402 to determine whether to score one or more consumable items. For example, nutrient evaluator 402 may determine an indicator as a function of an amount of sodium and/or cholesterol According to at least one embodiment, nutrient evaluator 402 is configured to perform a calorie check by calculating a total number of calories based on the following equation:

Total calories=4*[total amount of carbohydrates (g)+protein (g)]+9*[total amount of fat (g)],

whereby nutrient evaluator 402 can enable the scoring of the consumable item if the total calories from nutrient information 401 is within, for example, 30% of the above calculated total calories (or vice versa).

Nutrient association characterizer 404 is configured to characterize associations between a nutrient and one or more other nutrients or consumable characteristics. Nutrient association characterizer 404 is configured to identify a nutrient 431a and determine an association between nutrient 431a, as a first element, and a second element (i.e., another nutrient, a consumable characteristic, or any other item.). According to some examples, nutrient association characterizer 404 is configured to identify a nutrient 431a and determine an association 403 between nutrient 431a and another nutrient 431b. Association 403 can represent any type of relationship (e.g., numerical relationship) between an amount of nutrient 431a and an amount of nutrient 431b, and, as such, association 403 can contribute to a determination of an intermediate score 407 (e.g., a nutrient-related score). Association 403 can be indicative of a nutrient density based on at least nutrients 431a and 431b, whereby nutrient 431a can represent an amount of a health-promoting nutrient and nutrient 431b can represent an amount of a health-impairing nutrient. To illustrate, consider that an example of association 403 is a ratio of an amount of protein (in grams) to an amount of saturated fat (in grams) in a consumable item.

In another example, nutrient association characterizer 404 is configured to characterize in association 405 between nutrient 431a and a consumable characteristic 433, which is a characteristic of one or more consumables items (e.g., one or more food items). Association 405 also can represent any type of relationship (e.g., numerical relationship) between an amount of nutrient 431a and an amount associated with consumable characteristic 433. Further, association 405 can contribute to a determination of an intermediate score, from which indicator data 490 is derived. To illustrate, consider that an example of association 405 is a ratio of an amount of a nutrient (e.g., an amount of salt in milligrams) to an amount describing a characteristic in a consumable item (e.g., a unit amount of calories, such as 100 calories).

Note that nutrient association characterizer 404 can be configured to determine any number of associations from one or more nutrients 431a to one or more nutrients 431b, or to one or more consumable characteristics 433, to establish an indicator or food score. In some embodiments, a number of associations 403 and/or a number of associations 405 can be configured to include more or fewer associations to modify determination of indicator data 490 based on, for example, one or more of state data 111, conditional data 113, goal data 114, other data 115, weighting data 116, and the like.

Characterized association valuator 406 is configured to generate a value representative of an association characterized by nutrient association characterizer 404. Such a value can be descriptive of an amount, for example, of a health-promoting nutrient relative to an amount of a health-impairing nutrient for a food item. In some embodiments, the value derived by characterized association valuator 406 can be referred to as an immediate score 407, or a base score, that can be combined with other values representative of other associations characterized by nutrient association characterizer 404. In at least one example, a higher value that represents an association, such as a magnitude of a ratio, can be indicative of a more healthy combination of amounts of the corresponding nutrients (e.g., a more healthy combination of an amount of protein to an amount of saturated fats). Characterized association valuator 406 can determine a value by any manner, such as through a computation using equations, implementation of empirically-determined relationships, etc.

Weighting value unit 408 is configured to identify values of characterized associations, and further configured to apply a corresponding weight to either emphasize or deemphasize an impact of an intermediate score 407 in the formation of data representing food score 490. For example, condition data describing a user as having a hypertensive circulatory system can cause weighting value unit 408 to select a greater weighting value as applied to sodium (as a nutrient) to emphasize the deleterious effects of consuming food items having relatively large quantities of sodium. Weighting value unit 408 can be configured to apply different weighting values to different intermediate scores 407 as a function of any number of factors, whereby the one or more different weighting values can be configured to adapt food scoring for the particular needs of a user. Therefore, weighting value unit 408 can be configured to generate weighted, intermediate scores.

Nutrient-based modifier 410 is configured to modify a magnitude of an indicator or score to either boost or reduce the effects of a nutrient. In various examples, nutrient-based modifier 410 includes a booster 412 configured to boost effects of a nutrient, and a reducer 414 to reduce the effects of a nutrient. In some embodiments, nutrient-based modifier 410 can modify a magnitude of an intermediate score 407 or modify a weighted, intermediate score that may be generated by weighting value unit 408. In some cases, nutrient-based modifier 410 can modify a value of indicator data 490 representing a food score for a food item, or can modify a value of an indicator data 490 representing a food score for a combination of food items that constitute a meal, and the like.

To illustrate, consider a following example in which booster 412 is configured to add 1.5 points to a food score associated with any vegetable and/or fruit to emphasize the beneficial nutrients in such food, based on the quantities of vitamins, minerals, antioxidants and polyphenol content. Thus, booster 412 can be designed to encourage people to replace refined grains and sugars with vegetables and fruit. In another example, booster 412 is configured to add 0.5 points to a food score to boost a food score for a food item that is relatively high in potassium (e.g., in view of a USDA guideline or any other requirement, such as requested by a user). Thus, booster 412 is designed to encourage people to consume foods with relatively high potassium content, including beans, potatoes with skin, bananas, avocado, tomato, yogurt, dark leafy greens, etc. In yet another example, reducer 414 is configured to reduce or penalize a food score by an amount (e.g., −1.0 points) for food items that are relatively high in sodium content, thereby discouraging further consumption of foods with high levels of salt. Booster 412 and reducer 414 are not limited to the above-described nutrients and can operate in relation to any type of nutrient or consumable constituent.

Indicator calculator 420 is configured to receive one or more intermediate scores, one or more weighted, intermediate scores, and any other information for generating indicator data 490. In some embodiments, indicator data 490 represents a food score that is a weighted average of intermediate or “healthiness” scores.

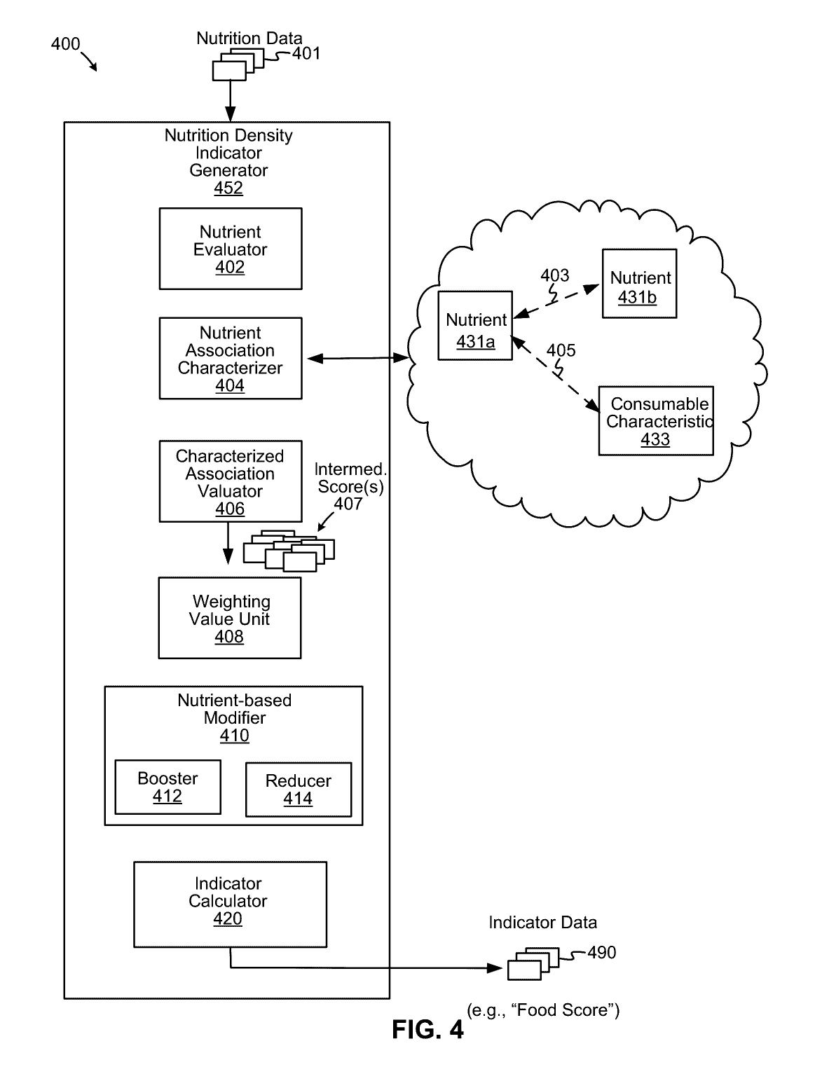

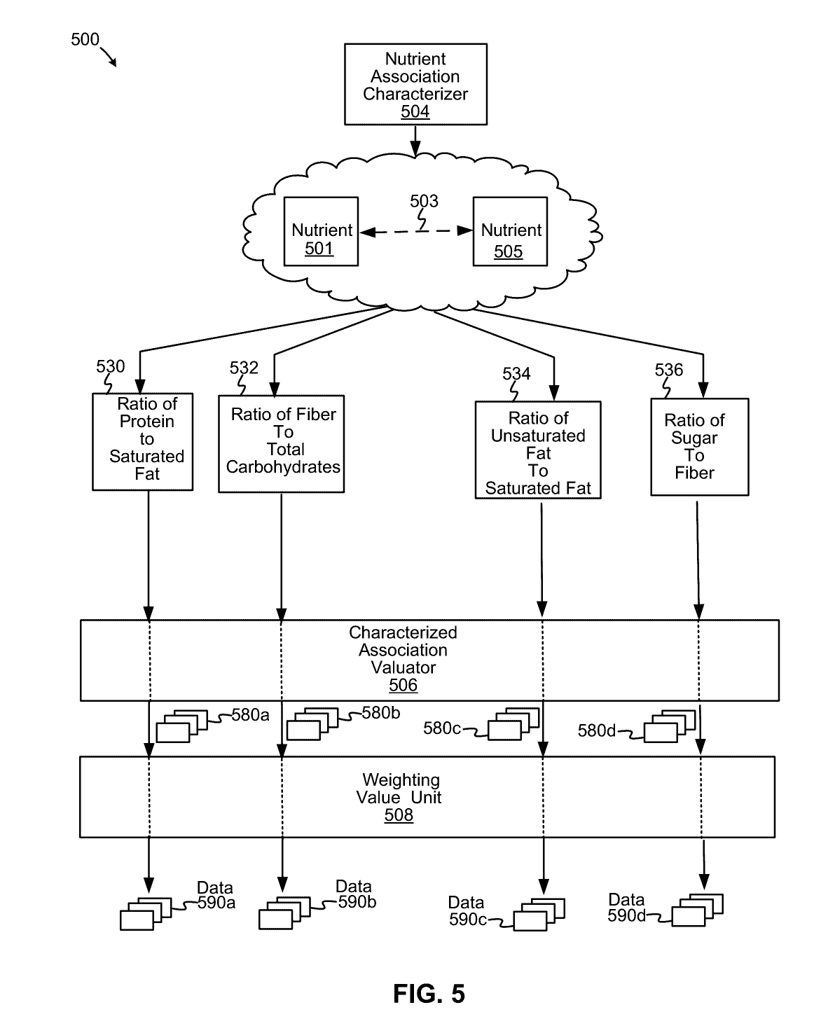

FIG. 5 is a diagram depicting operation of a nutrient association characterizer, according to some embodiments. Diagram 500 includes a nutrition association characterizer 504, a characterized association valuator 506, and a weighting value unit 508. Nutrition association characterizer 504 is configured to characterize a number of associations 503 between a number of pairs of nutrients 501 and 505. A nutrient can include a macronutrient, such as protein, fat, and carbohydrates, a macromineral, such as calcium, chloride, potassium, sodium, and others, vitamins, trace minerals, fortifications, ingredients, ingredient origin, farming methods, and the like.

In a first example, nutrition association characterizer 504 characterizes an association between protein, as a nutrient 501, and saturated fat, as nutrient 505, whereby the characterized association represents a magnitude of a ratio 530 of protein to saturated fat. A range of magnitudes for the ratio of protein to saturated fats is configured to adapt a food score to encourage people to eat food items that include protein with relatively low amounts of saturated fats to reduce risk factors for cardiovascular disease. Consider a second example, in which nutrition association characterizer 504 characterizes an association between fiber, as a nutrient 501, and a total amount of carbohydrates, as nutrient 505, whereby the characterized association represents a magnitude of a ratio 532 of fiber to total carbohydrates. A range of magnitudes for the ratio of fiber to total carbohydrates is configured to adapt a food score to encourage people to focus on foods having relatively high amounts of fiber, including foods such as vegetables, fruits and whole grains to help reduce the risk of cardiovascular disease, obesity and type II diabetes. Note, too that foods that are naturally high in fiber may be more nutrient dense, thereby helping to control insulin and blood sugar levels as well as promoting gastrointestinal health.

In a third example, nutrition association characterizer 504 characterizes an association between unsaturated fat, as a nutrient 501, and saturated fat, as nutrient 505, whereby the characterized association represents a magnitude of a ratio 534 of unsaturated fat to saturated fat. A range of magnitudes for the ratio of unsaturated fat to saturated fat may be configured to adapt a food score to include foods that have relatively more unsaturated fats, which promote health by lowering LDL (i.e., bad) cholesterol and by improving insulin levels for people with type II diabetes. Generating a food score that deemphasizes consumption of food that includes saturated fat can emphasize food items that reduce risk for heart disease. In a fourth example, nutrition association characterizer 504 characterizes an association between sugar, as a nutrient 501, and fiber, as nutrient 505, whereby the characterized association represents a magnitude of a ratio 536 of sugar to fiber. A range of magnitudes for the ratio of sugar to fiber can be configured to encourage people to reduce consumption of food items that include added sugars, thereby encouraging a person to lower their caloric intake without compromising nutrient. Further, foods that include added sugars may lack sufficient amounts of fiber to reduce insulin responses. In view of the foregoing, more or fewer ratios can be evaluated according to various embodiments. Further, note that other associations between other nutrients can be selected in accordance with, for example, the USDA dietary guidelines, user-defined nutrient guidelines, and the like.

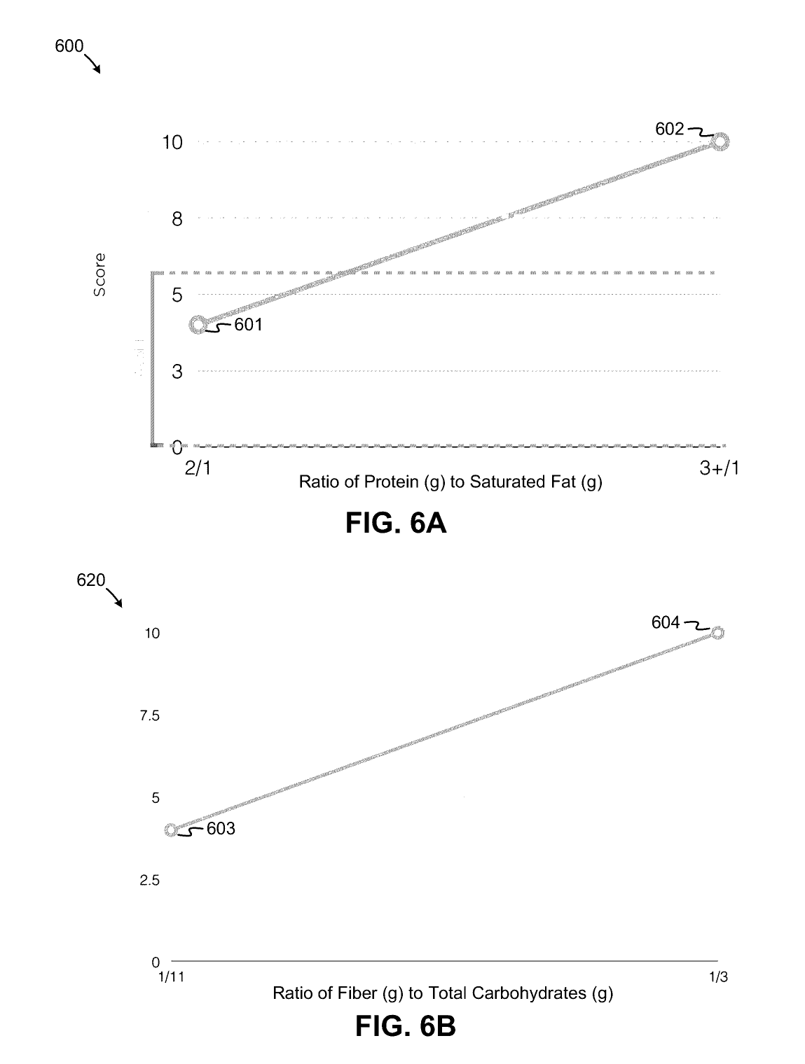

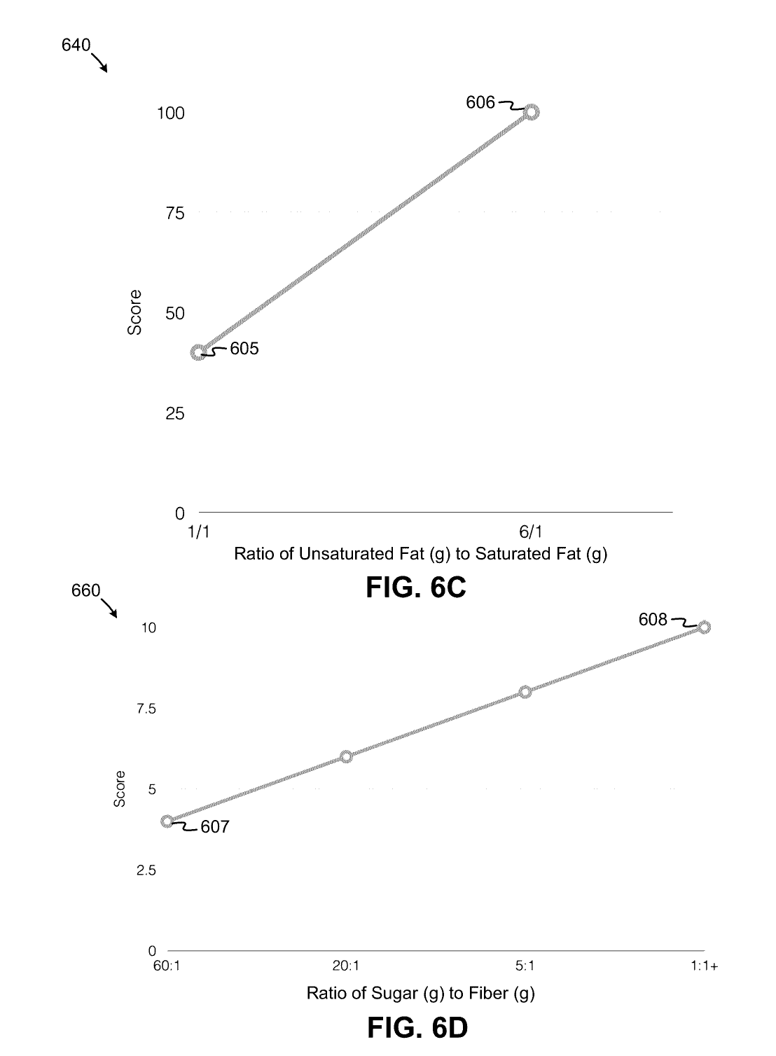

Ratio magnitudes 530, 532, 534, and 536 are provided to characterized association valuator 506, which, in turn, generates values 580a, 580b, 580c, and 580d, respectively for the characterized associations. According to some embodiments, values 580a, 580b, 580c, and 580d can be determined, in at least some examples, as intermediate scores derived from FIGS. 6A, 6B, 6C, and 6D, respectively. To illustrate, consider that ratio magnitude 530 is about 3/1. According to the diagram 600 in FIG. 6A, ratio 3/1 generates an intermediate score of 10. The other intermediate scores are similarly determined, at least in the example shown. Note that characterized association valuator 506 is not limited to the use of relationships in FIGS. 6A, 6B, 6C, and 6D to generate intermediate scores, which can be determined in other ways.

Weighting value unit 508 is configured to apply weights to intermediate scores associated with values 580a, 580b, 580c, and 580d to respectively generate weighted, intermediate scores 590a, 590b, 590c, and 590d, which, in turn, can be provided to an indicator calculator for generating a food score for one or more consumable items. In some examples, weighting value unit 508 is configured to apply a weight of three (“3”) to values 580a, 580b, 580c, and 580d. However, weighting value unit 508 can apply any other weights to values 580a, 580b, 580c, and 580d, according to other embodiments.

According to at least one embodiment, a nutrient evaluator 402 of FIG. 4 is configured to detect whether an amount of saturated fat is greater than 1 g, and, if not, nutrient evaluator 402 is configured to disable the determination of ratio 530 of FIG. 5. Nutrient evaluator 402 of FIG. 4 is configured to detect whether a total amount of carbohydrates is greater than 1 g, and, if not, nutrient evaluator 402 is configured to disable the determination of ratio 532 of FIG. 5. Similarly, nutrient evaluator 402 of FIG. 4 can detect whether an amount of total fat and amount of sugar is greater than 1 g and 0.2 g, respectively, and, if not, nutrient evaluator 402 is configured to disable the determination of respective ratios 534 and 536 of FIG. 5. Note, however, a nutrient evaluator of the various embodiments need not be limited to determining whether to enable or disable the use of ratios based on the aforementioned values, but rather can do so based on other amounts of saturated fat, total amount of carbohydrates, total fat, and sugar.

FIGS. 6A, 6B, 6C, and 6D are examples of graphical relationships to determine intermediate scores, according to some embodiments, based on a ratio of protein to saturated fat in diagram 600 of FIG. 6A, a ratio of fiber to total carbohydrates in diagram 620 of FIG. 6B, a ratio of unsaturated fat to saturated fat in diagram 640 of FIG. 6C, and a ratio of sugar to fiber in diagram 660 of FIG. 6D.

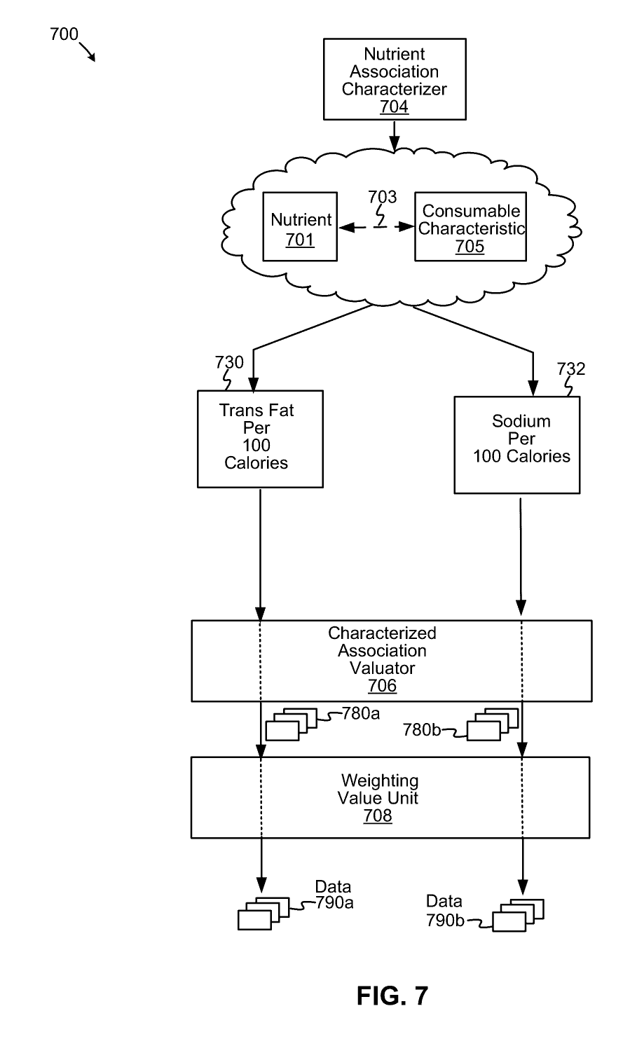

FIG. 7 is a diagram depicting additional functionality of a nutrient association characterizer, according to some embodiments. Diagram 700 includes a nutrition association characterizer 704, a characterized association valuator 706, and a weighting value unit 708. Nutrition association characterizer 704 is configured to characterize a number of associations 703 between a nutrient 701 and a consumable characteristic 705. According to some embodiments, a consumable characteristic can refer to an attribute of a consumable item, such as an amount of calories, whether a food product is “organic,” or has other distinctive characteristics. Further, a consumable characteristic can include an attribute of a food item based on one or more of the following: attributes of a combination of protein, fat, and carbohydrates, such as an amount of calories, attributes of a combination of one or more macromineral (e.g., calcium, chloride, potassium, sodium, etc.), attributes of vitamins, attributes of trace minerals, attributes of fortifications, attributes of ingredients, attributes of ingredient origin, attributes of farming methods (e.g., organic farming), and the like.

In a first example, nutrition association characterizer 704 characterizes an association 703 between trans fat, as a nutrient 701, and a unit of 100 calories, as consumable characteristic 705, whereby the characterized association represents a magnitude 730 of an amount of trans fat per 100 calories. A range of magnitudes of trans fat per 100 calories is configured to adapt a food score to encourage people to avoid most quantities of trans fat acids as they may be a relatively non-essential part of a diet and have been associated with increased of cardiovascular disease.

In a second example, nutrition association characterizer 704 characterizes an association 703 between sodium, as a nutrient 701, and an amount of sodium, as consumable characteristic 705, whereby the characterized association represents a magnitude 732 of sodium per 100 calories. A range of magnitudes of sodium per 100 calories is configured to adapt a food score to encourage people limit sodium intake to less than, for example, 2300 mg per day to assist in lowering blood pressure levels. Note that a default minimum amount of sodium may bet set to 1500 mg per day. In view of the foregoing, more or fewer associations between one or more nutrients and one or more consumable characteristics can be evaluated according to various embodiments. Further, note that other associations between other nutrients can be selected in accordance with, for example, the USDA dietary guidelines.

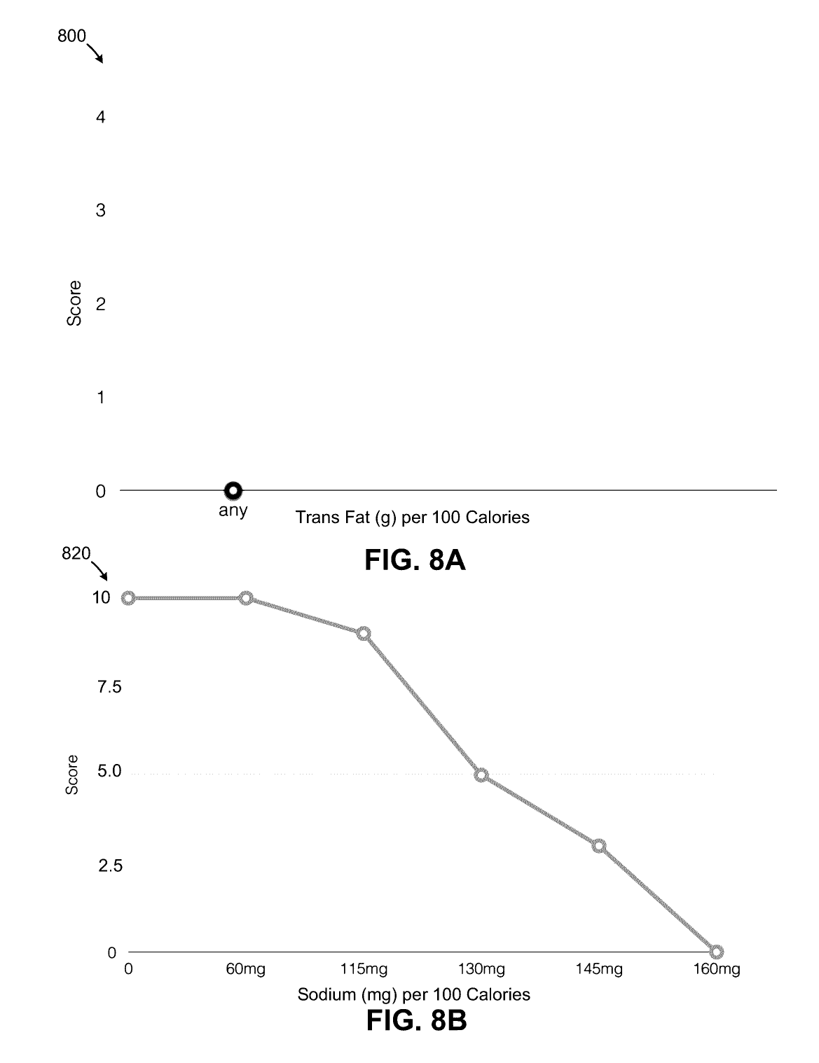

Magnitudes 730 and 732 are provided to characterized association valuator 706, which, in turn, generates values 780a and 780b, respectively for the characterized associations. According to some embodiments, values 780a and 780b can be determined, in at least some examples, as intermediate scores derived from FIGS. 8A and 8B, respectively. To illustrate, consider that magnitude 732 is about 130 mg Sodium (per 100 calories). According to the diagram 820 in FIG. 8B, magnitude 130 mg generates an intermediate score of 5.0. The other intermediate scores are similarly determined, at least in the example shown. Note that characterized association valuator 706 is not limited to the use of relationships in FIGS. 8A and 8B to generate intermediate scores, which can be determined in other ways.

Weighting value unit 708 is configured to apply weights to intermediate scores associated with values 780a and 780b to respectively generate weighted, intermediate scores 790a and 790b, which, in turn, can be provided to an indicator calculator for generating a food score for one or more consumable items. In some examples, weighting value unit 708 is configured to apply a weight of three (“3”) to value 780a. Further, weighting value unit 708 is configured to apply either a weight of one (“1”) to value 780b, if a total amount of sodium over a unit time interval is less than 2300 mg, or a weight of three (“3”) to value 780b, if the sodium amount is or exceeds 2300 mg. However, weighting value unit 708 can apply other weights to values 780a and 780b, according to other embodiments.

According to at least one embodiment, a nutrient evaluator 402 of FIG. 4 is configured to detect whether amounts of trans fat or sodium, or others, are detectable, and if not, nutrient evaluator 402 is configured to disable the determination of a corresponding magnitudes 730 and 732 of FIG. 7. Note, however, a nutrient evaluator of the various embodiments need not be limited to requiring a determination whether to enable or disable the use of magnitude, ratios, or the like.

FIGS. 8A and 8B are examples of graphical relationships to determine intermediate scores, according to some embodiments, based on a magnitude of trans fat per 100 calories in diagram 800 of FIG. 8A and a magnitude of sodium per 100 calories in diagram 820 of FIG. 8B.

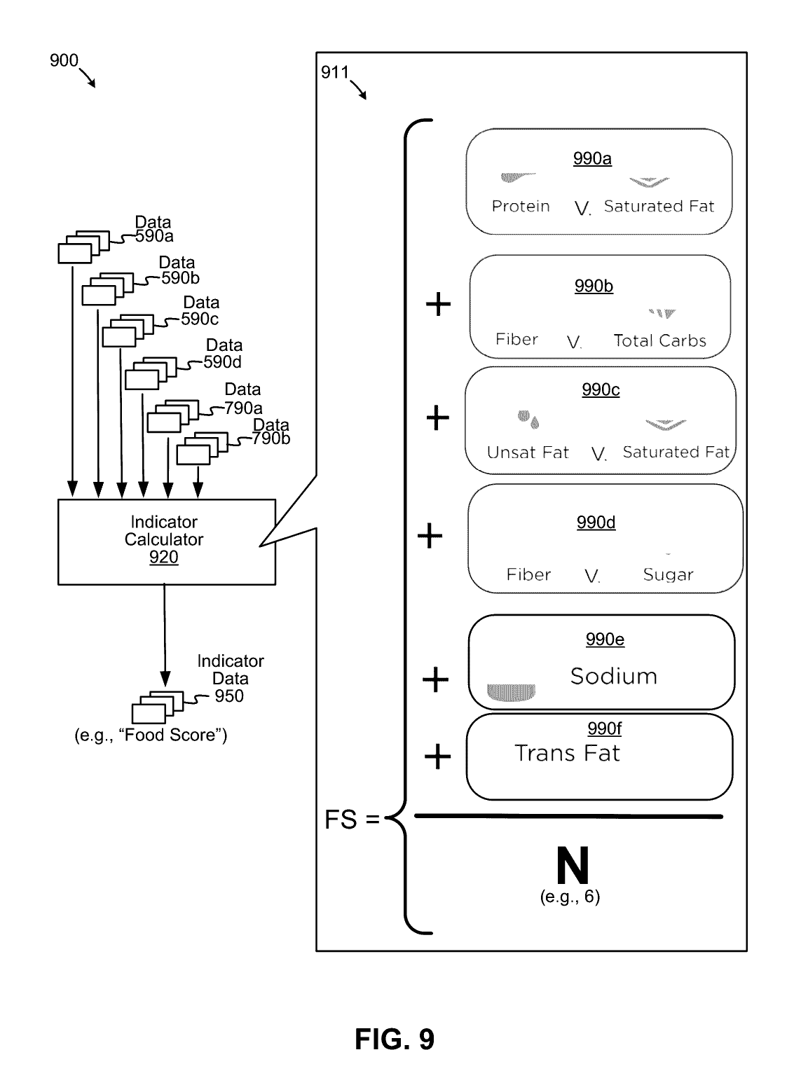

FIG. 9 depicts an indicator calculator configured to generate an indicator, according to some embodiments. Diagram 900 depicts an indicator calculator 920 receiving data representing weighted, intermediate scores 590a, 590b, 590c, and 590d of FIG. 5 and data representing weighted, intermediate scores 790a and 790b. Indicator calculator 920 is configured to generate data representing an indicator 950, which can be described as a food score that is indicative of a degree of “healthiest” of a food item, meal, or a collection of meals based on, for example, the nutrient density or densities of a subset of nutrients and the like. Indicator calculator 920 can also boost or reduce one or more of the above values to generate indicator 950.

Indicator calculator 920 is configured to derive indicator 950 from data 590a, 590b, 590c, 590d, 790a and 790b based on one or more analysis techniques. In some embodiments, indicator calculator 920 is configured to calculate a food score as, for example, depicted as a weighted average 911. As shown, weighted average 911 is derived by emphasizing, via weights applied by a weighting value unit, certain nutrient-based associations to generate values 590a, 590b, 590c, 590d, 790a and 790b. In at least one case, values 590a, 590b, 590c, 590d, 790a and 790b are processed as values 990a, 990b, 990c, 990d, 990e, and 990f, which are then normalized to a food score scale (e.g., from 0 to 10). For example, a combination of values 990a, 990b, 990c, 990d, 990e, and 990f can be normalized by dividing with a number of values, N, which, in this example, is six (6). Note that indicator calculator 920 is not limited to generating a food score is described in FIG. 9 and can implement other techniques for generating the food score.

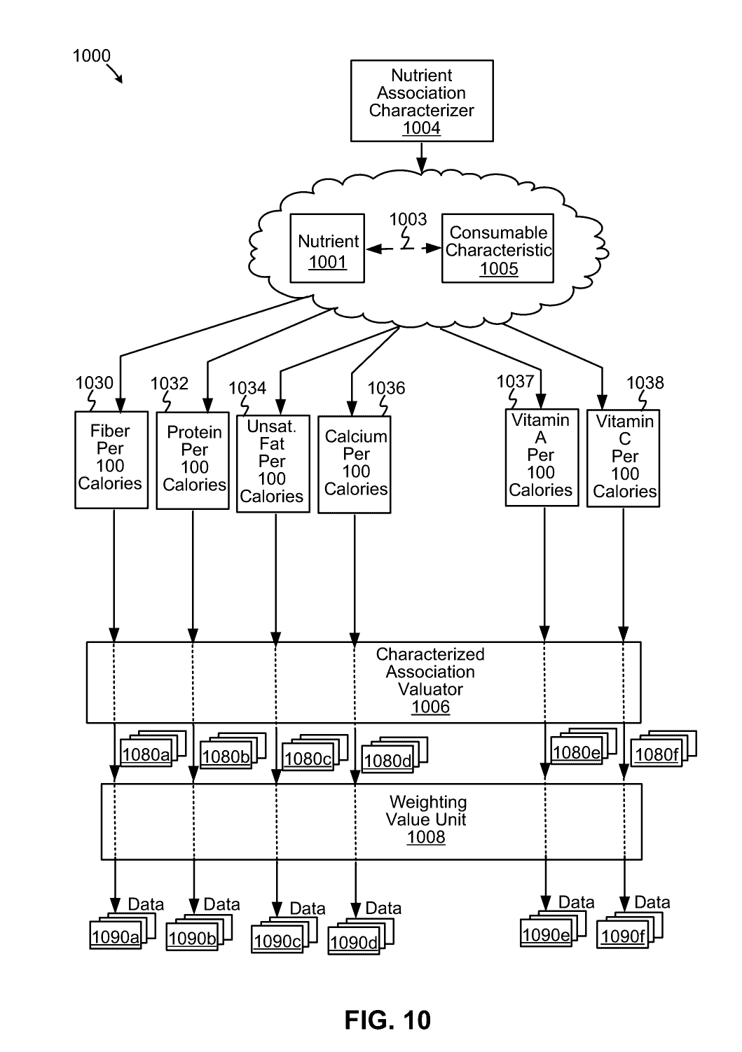

FIG. 10 is a diagram depicting another example of a nutrient association characterizer, according to some embodiments. Diagram 1000 includes a nutrition association characterizer 1004, a characterized association valuator 1006, and a weighting value unit 1008. In this example, nutrition association characterizer 1004 is configured to characterize a number of associations 1003 between a number of nutrients 1001 and a number of consumable characteristics 1005.

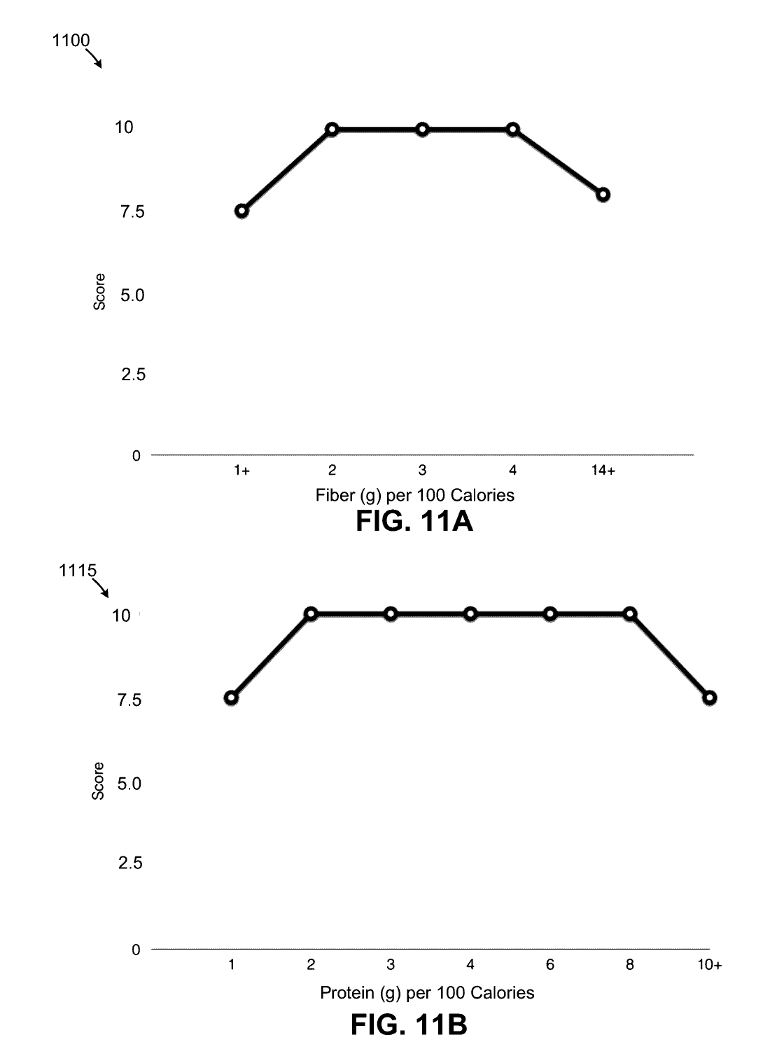

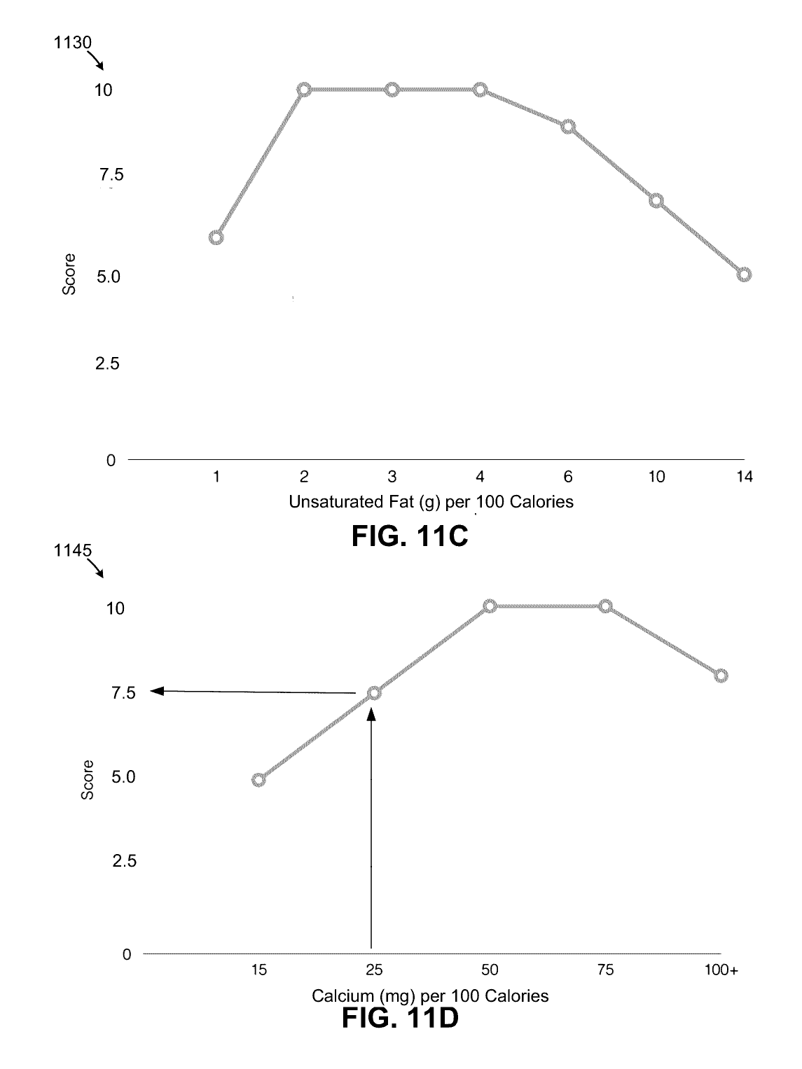

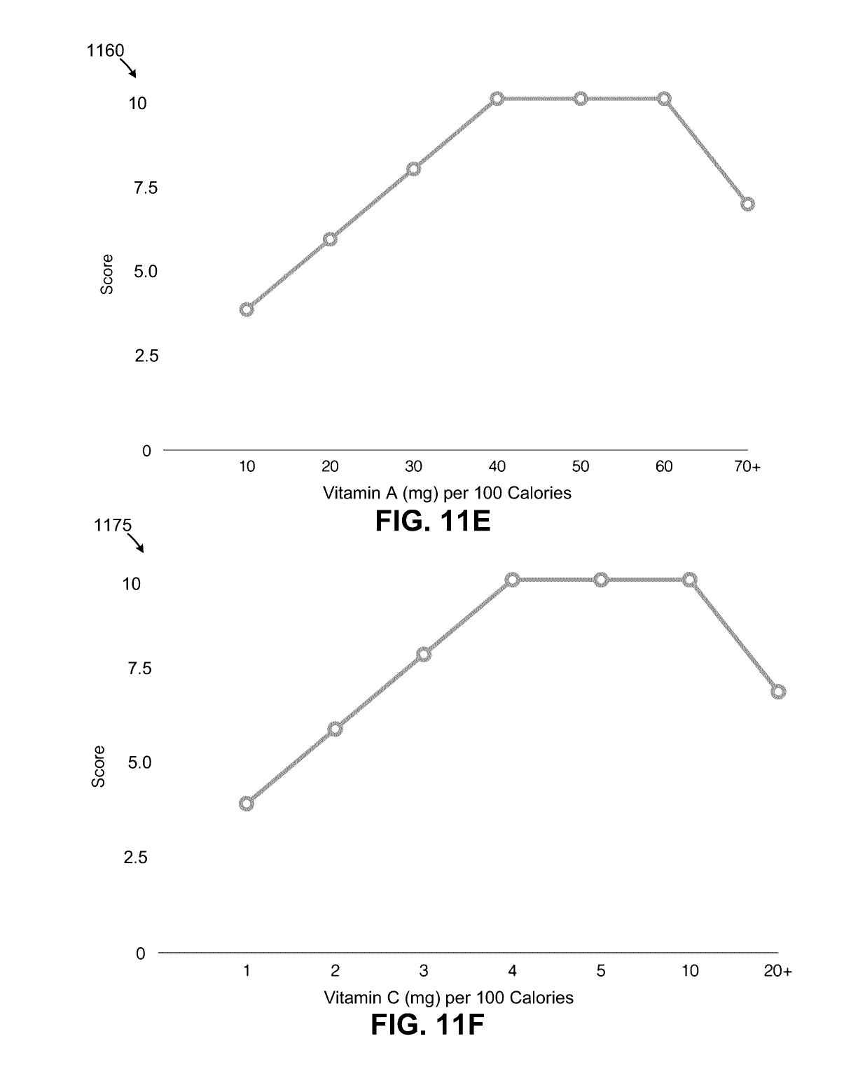

In the example shown, nutrition association characterizer 1004 is configured to characterize a number of associations of health-promoting nutrients relative to a unit amount of calories (e.g., 100 calories). Nutrient association characterizer 1004 is configured to derive a magnitude 1030 of fiber, a magnitude 1032 of protein, a magnitude 1034 of unsaturated fat, a magnitude 1036 of calcium, a magnitude 1037 of vitamin A, and a magnitude 1038 of vitamin C, the magnitudes of which can be relative per unit number of calories (e.g., 100 calories). Further, magnitudes 1030, 1032, 1034, 1036, 1037, and 1038 can be provided to characterized association valuator 1006, which, in turn, generates values 1080a, 1080b, 1080c, 1080d, 1080e and 1080f, respectively for the characterized associations. According to some embodiments, values 1080a, 1080b, 1080c, 1080d, 1080e and 1080f can be determined, in at least some examples, as intermediate scores derived from FIGS. 11A, 11B, 11C, 11D, 11E, and 11F, respectively.

To illustrate, consider that a selection of a meal or food items provides a magnitude 1036 of about 25 mg calcium per 100 calories. According to diagram 1145 in FIG. 11D, 25 mg calcium generates an intermediate score of 7.5. The other intermediate scores can be similarly determined, at least in the example shown. Note that characterized association valuator 1006 is not limited to the use of relationships in FIGS. 11A, 11B, 11C, 11D, 11E, and 11F to generate intermediate scores, which can be determined in other ways.

Weighting value unit 1008 is configured to apply weights to intermediate scores associated with values 1080a, 1080b, 1080c, 1080d, 1080e and 1080f to respectively generate weighted, intermediate scores 1090a, 1090b, 1090c, 1090d, 1090e and 1090f, which, in turn, can be provided to an indicator calculator for generating a food score for one or more consumable items. In some examples, weighting value unit 1008 is configured to apply a weight of six (“6”) to value 1080a, apply a weight of four (“4”) to value 1080b, and a weight of two (“2”) to value 1080c. Further, weighting value unit 1008 is configured to apply a weight of one (“1”) to values 1080d, 1080e, and 1080f. However, weighting value unit 1008 can apply other weights to values 1080a to 1080f, according to other embodiments.

Note that a nutrient evaluator of the various embodiments can determine whether to enable or disable the use of the above-described magnitudes based on a presence of a corresponding nutrient in a food item.

FIGS. 11A, 11B, 11C, 11D, 11E, and 11F are examples of graphical relationships that can be used to determine intermediate scores based on a magnitude, according to some embodiments. Diagram 1100 of FIG. 11A is configured provide a relationship with which to generate favorable food scores when a magnitude of fiber is between 2.0 g and 3.5 g per 100 calories, whereas diagram 1115 of FIG. 11B is configured provide a relationship with which to generate favorable food scores when a magnitude of protein is between 2.5 g and 8.0 g per 100 calories. Diagram 1130 of FIG. 11C is configured provide a relationship to generate scores when a magnitude of unsaturated fat is between 2.0 g and 3.8 g per 100 calories, whereas diagram 1145 of FIG. 11D is configured provide a relationship to generate favorable food scores when a magnitude of calcium is about 50 mg per 100 calories. Diagram 1160 of FIG. 11E is configured provide a relationship to generate scores when a magnitude of vitamin A is at about mcg per 100 calories, whereas diagram 1175 of FIG. 11F is configured provide a relationship to generate favorable food scores when a magnitude of vitamin C is about 4.5 mg per 100 calories.

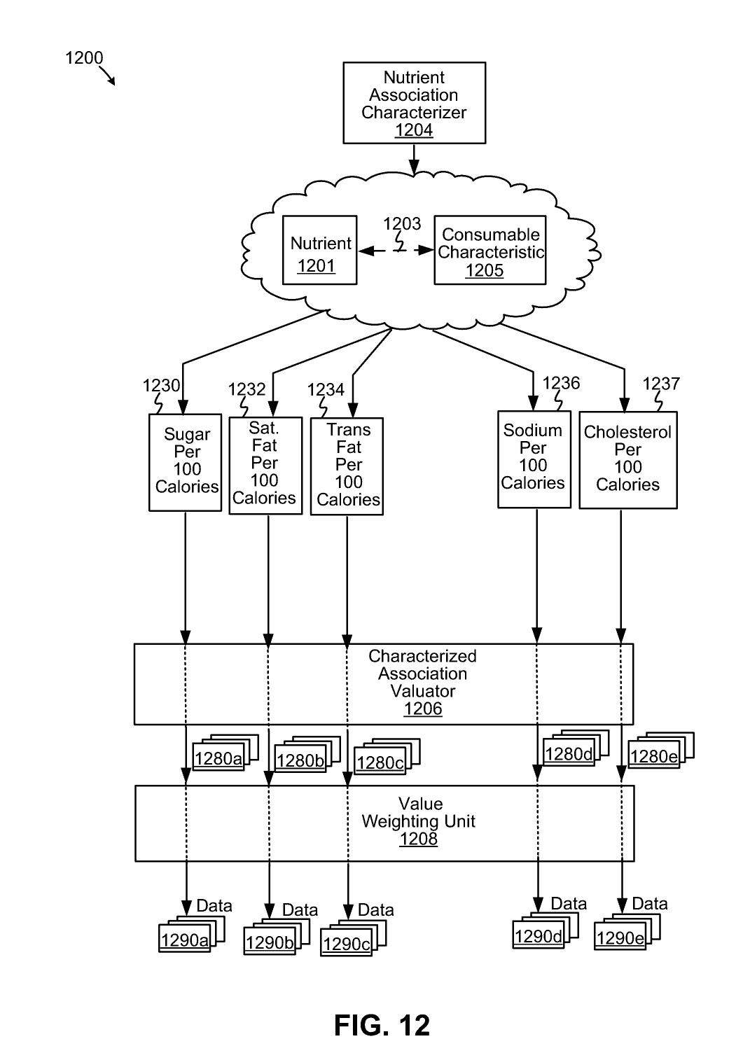

FIG. 12 is a diagram depicting yet another example of a nutrient association characterizer, according to some embodiments. Diagram 1200 includes a nutrition association characterizer 1204, a characterized association valuator 1206, and a weighting value unit 1208. In this example, nutrition association characterizer 1204 is configured to characterize a number of associations 1203 between a number of nutrients 1201 and a number of consumable characteristics 1205. In the example shown, nutrition association characterizer 1204 is configured to characterize a number of associations of health-impairing or deteriorating nutrients relative to a unit amount of calories (e.g., 100 calories). Such nutrients can be included in a food score determination since their presence can be unhealthy relative to an amount in a food item, whereas the reduction of such an amount contributes to increases in a food score.

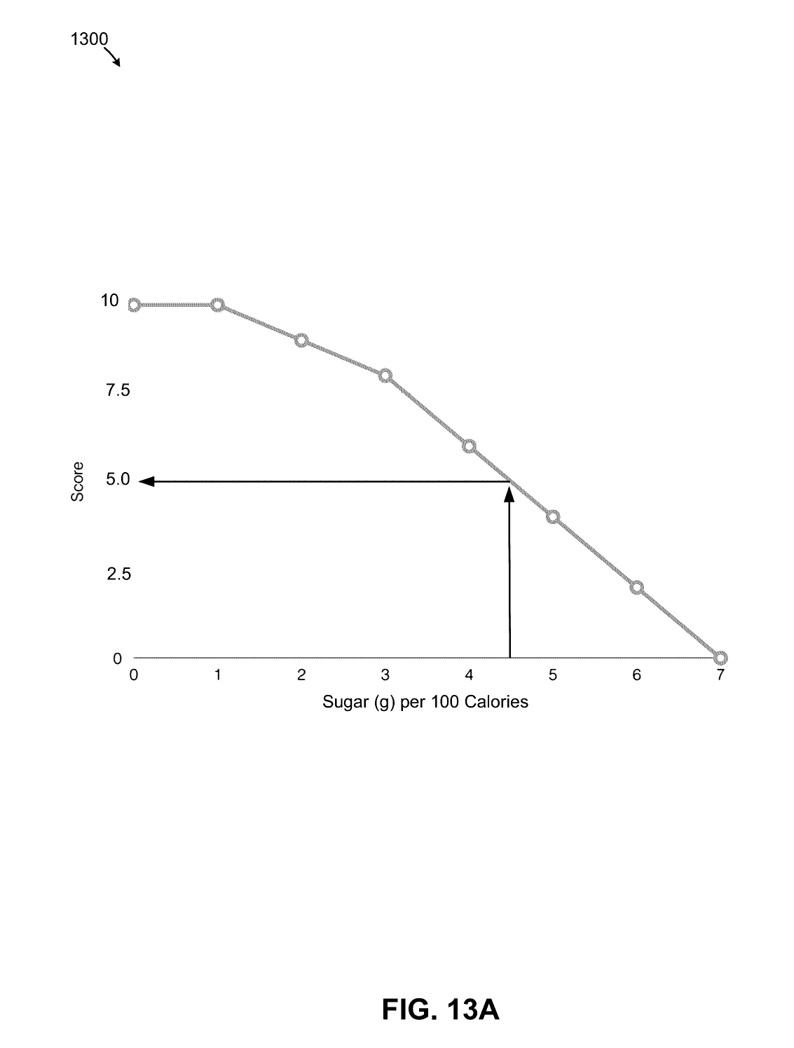

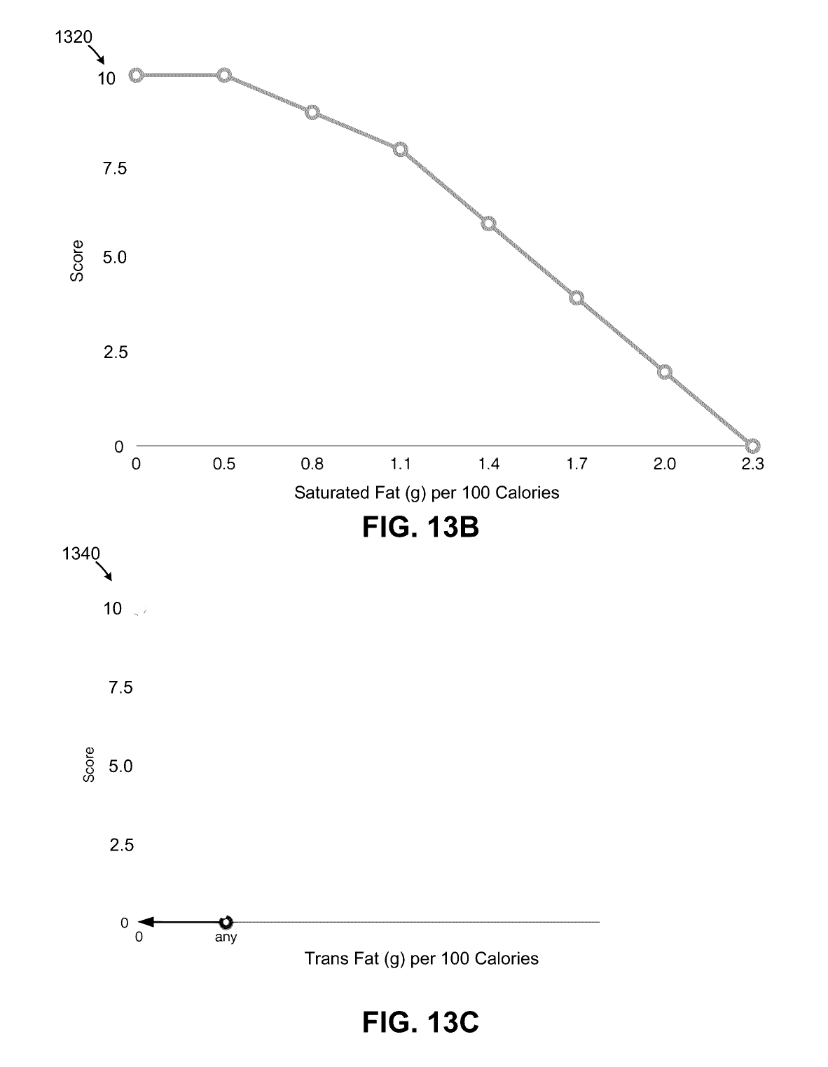

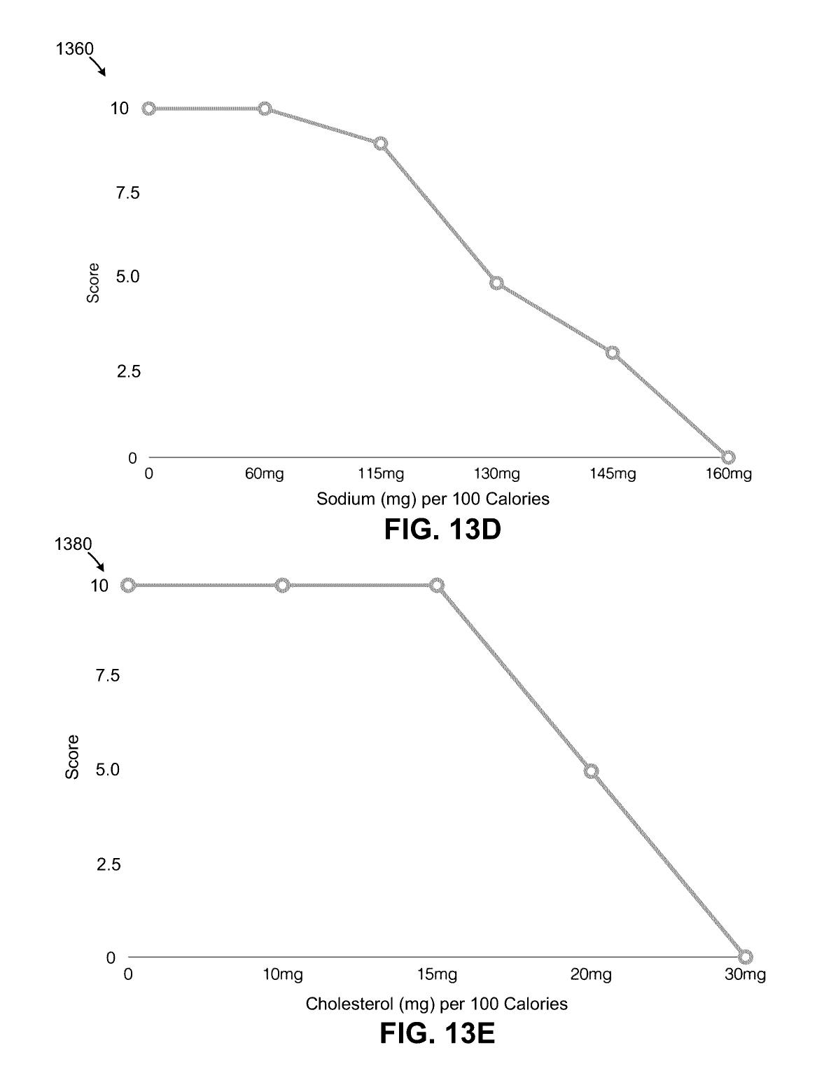

Nutrient association characterizer 1204 is configured to derive a magnitude 1230 of sugar, a magnitude 1232 of saturated fat, a magnitude 1234 of trans fat, a magnitude 1236 of sodium, and a magnitude 1237 of cholesterol, the magnitudes of which can be relative per unit number of calories (e.g., 100 calories). Further, magnitudes 1230, 1232, 1234, 1236, and 1237 can be provided to characterized association valuator 1206, which, in turn, generates values 1280a, 1280b, 1280c, 1280d, and 1280e, respectively for the characterized associations. According to some embodiments, values 1280a, 1280b, 1280c, 1280d, and 1280e can be determined, in at least some examples, as intermediate scores derived from FIGS. 13A, 13B, 13C, 13D, and 13E, respectively.

To illustrate, consider that a selection of a meal or food items provides a magnitude 1236 of about 4.5 g sugar per 100 calories. According to the diagram 1300 in FIG. 13A, 4.5 g sugar generates an intermediate score of 5.0. The other intermediate scores can be similarly determined, at least in the example shown. Note that characterized association valuator 1206 is not limited to the use of relationships in FIGS. 13A, 13B, 13C, 13D, and 13E to generate intermediate scores, but rather can be determined in other ways.

Weighting value unit 1208 is configured to apply weights to intermediate scores associated with values 1280a, 1280b, 1280c, 1280d, and 1280e to respectively generate weighted, intermediate scores 1290a, 1290b, 1290c, 1290d, and 1290e, which, in turn, can be provided to an indicator calculator for generating a food score for one or more consumable items. In some examples, weighting value unit 1208 is configured to apply a weight of two (“2”) to values 1280a and 1280d. Further, weighting value unit 1208 is configured to apply a weight of four (“4”) to value 1280b, apply a weight of ten (“10”) to value 1280c, and a weight of one (“1”) to value 1280e. Note, however, weighting value unit 1208 is not so limiting and can apply other weights to values 1280a to 1280f, according to other embodiments.

Note that a nutrient evaluator of the various embodiments can determine whether to enable or disable the use of the above-described magnitudes based on a presence of a corresponding nutrient in a food item.

FIGS. 13A, 13B, 13C, 13D, and 13E are examples of graphical relationships that can be used to determine intermediate scores based on a magnitude, according to some embodiments. Diagram 1300 of FIG. 13A is configured provide a relationship with which to generate favorable food scores when a magnitude of sugar is less than about 3.5 g per 100 calories, whereas diagram 1320 of FIG. 13B is configured provide a relationship to generate favorable food scores for magnitudes of saturated fats less than 1.1 g per 100 calories. Diagram 1340 of FIG. 13C is configured provide a relationship to generate scores indicative of the impairing nature of consumption of trans fats. In particular, any magnitude of trans fat per 100 calories produces a score of zero. Diagram 1360 of FIG. 13D is configured provide a relationship to generate scores when a magnitude of sodium is less than about 115 mg per 100 calories, whereas diagram 1380 of FIG. 13E is configured provide a relationship to generate favorable food scores when a magnitude of cholesterol is less than about 15 mg per 100 calories.

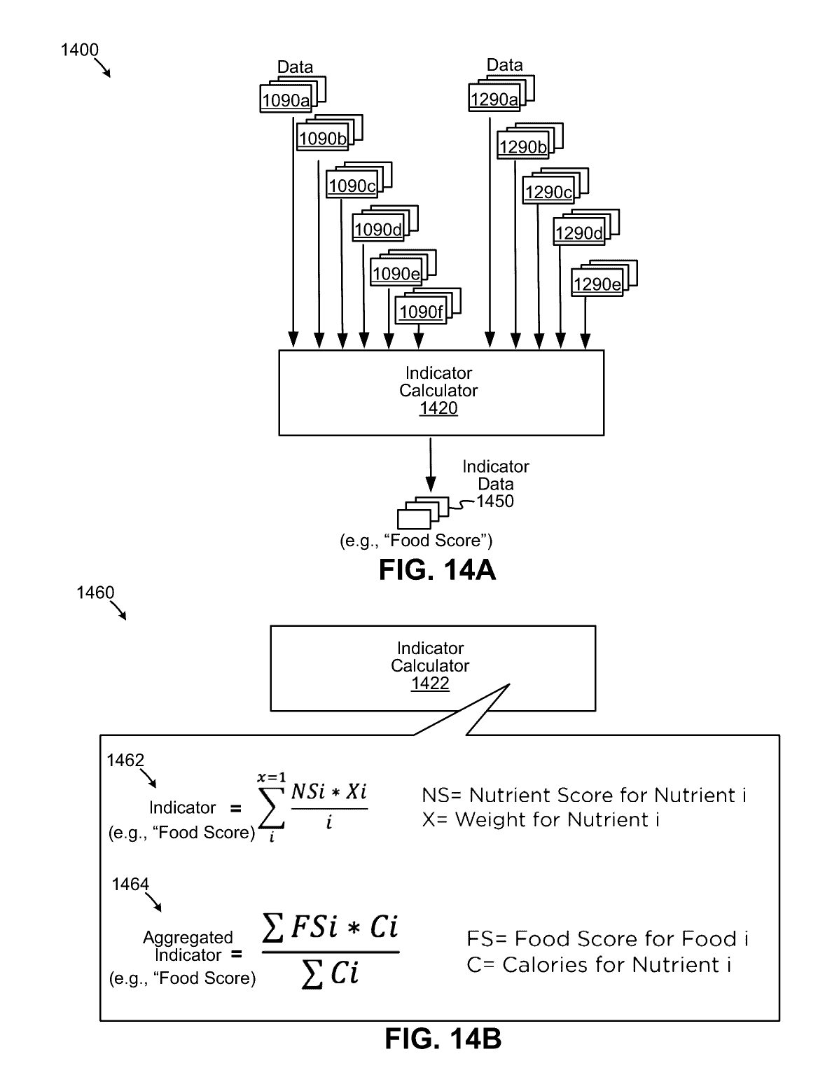

FIGS. 14A and 14B depict examples of indicator calculators configured to generate an indicator, according to some embodiments. Diagram 1400 of FIG. 14A depicts an indicator calculator 1420 receiving data representing weighted, intermediate scores 1080a, 1080b, 1080c, 1080d, 1080e and 1080f of FIG. 10 and data representing weighted, intermediate scores 1280a, 1280b, 1280c, 1280d, and 1280e of FIG. 12. Indicator calculator 1420 is configured to generate data representing an indicator 1450, which can be described as a food score that is indicative of a degree of “healthiest” of a food item, meal, or a collection of meals based on, for example, the nutrient density or densities of a subset of nutrients and the like. Indicator calculator 1420 can also boost or reduce one or more of the above values to generate indicator 1450. Indicator calculator 1420 is configured to derive indicator 1450 from data 1080a, 1080b, 1080c, 1080d, 1080e, 1080f, 1280a, 1280b, 1280c, 1280d, and 1280e based on one or more analysis techniques, and is not limited to those described herein.

FIG. 14B depicts an example of an indicator calculator 1422 that is configured to generate a food score for the consumable item based on a weighted average of individual nutrient scores (e.g., weighted or on weighted values of intermediate scores). As shown in diagram 1460, indicator calculator 1422 can generate an indicator 1462 based on a weighted average of nutrient scores (“NS”). In some embodiments, individual nutrient scores can be based on USDA recommendations, and can vary or be modified responsive to the needs of a user based on activity, sleep, mood, and other factors relevant to the health and wellness of the specific user. Further, indicator calculator 1422 is configured to determine a food score 1464 of a meal (e.g., grouping of consumable or food items) or a daily food score 1464 for a group of meals (e.g., consumed over the course of 24 hours).

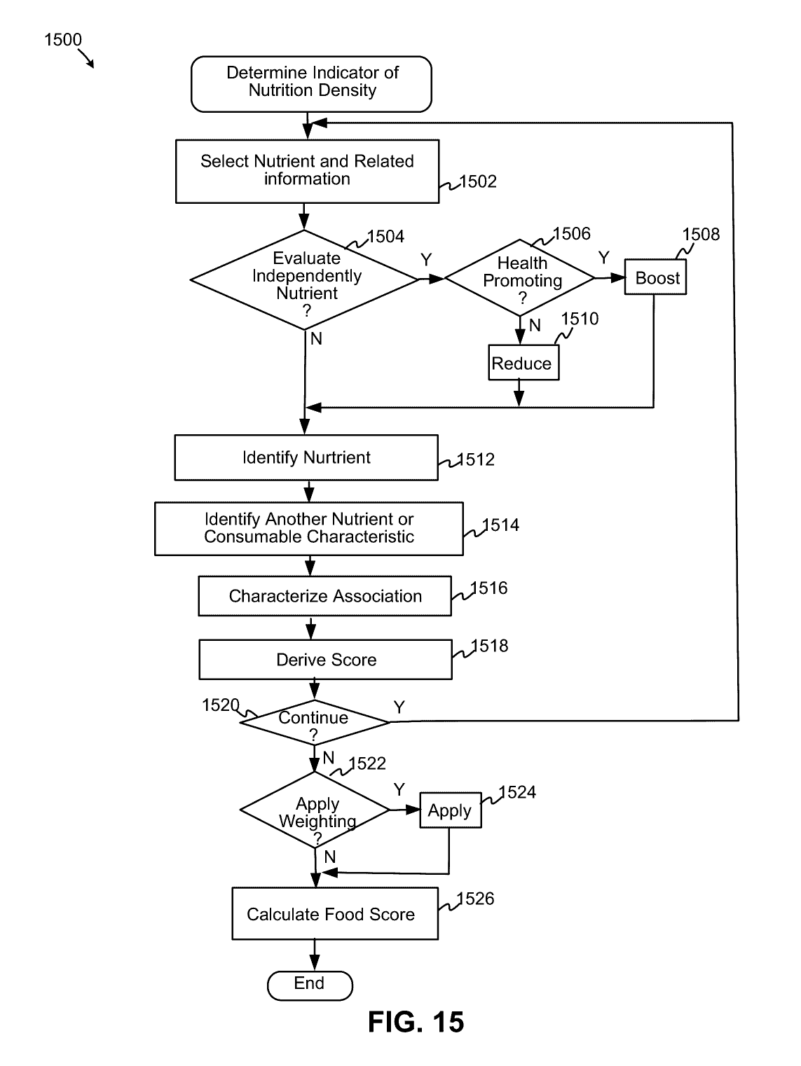

FIG. 15 is an example of a flow diagram to calculate an indicator of a density of nutrients for consumable items, according to some embodiments. At 1502, flow 1500 causes a selection of a nutrient and related information (e.g., quantities, serving sizes, types of nutrients, etc.). An optional determination is made at 1504 whether to evaluate a nutrient independently. If so, a determination is made whether the nutrient is a health-promoting nutrient at 1506. If so, a boost value is determined at 1508 to nudge a food score positively based on a choice food items. If not (i.e., a nutrient is not health promoting), a value to reduce a food score negatively is determined at 1510.

At 1512, a nutrient is identified. At 1514, either another nutrient or a consumable characteristic is identified. At 1516, an association is determined either between two nutrients or between a nutrient and a consumable characteristic, and the association is characterized to describe the relationship and/or dependency between the two items. In relationship and/or dependency can be expressed as, for example, a ratio, a magnitude, or by any other numerical or arithmetic representation. At 1518, a score is derived (e.g., a nutrient score or intermediate score). Flow 1500, responsive to an affirmative determination at 1522, can continue to 1522. At 1522, a determination is made as to whether to apply a weighting value. If so, the weight is applied to, for example, a nutrient score at 1524. If not, flow 1500 moves to 1526, at which a food score is determined (e.g., an indicator is calculated).

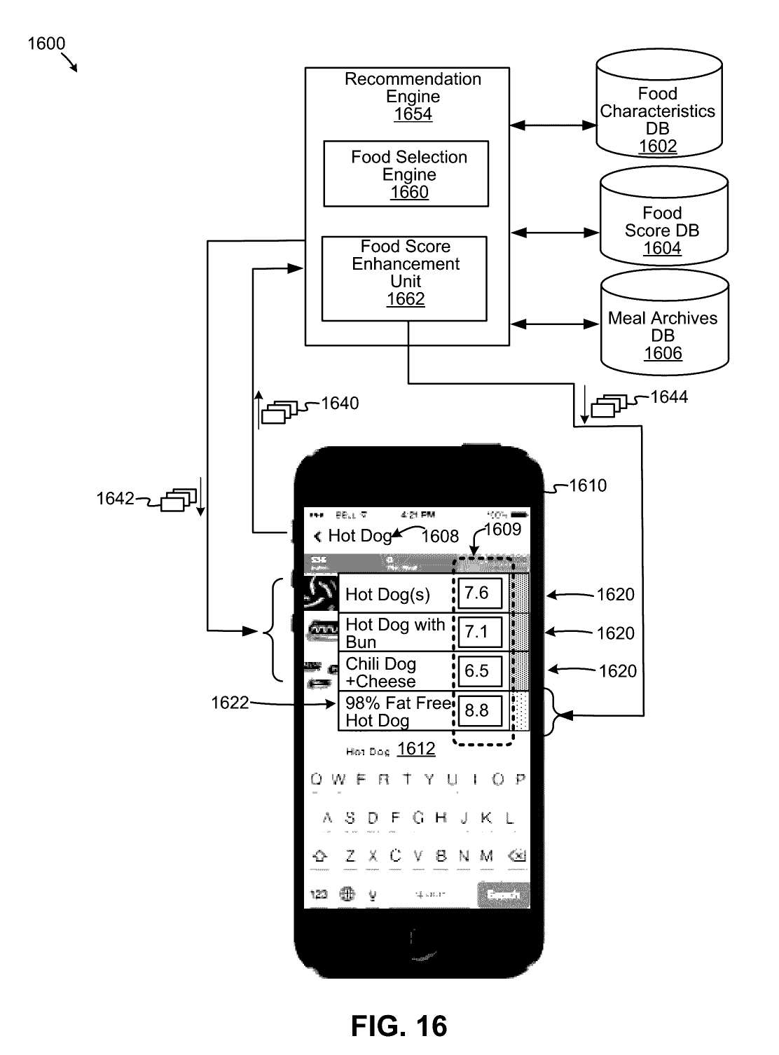

FIG. 16 is a diagram depicting a recommendation engine, according to some examples. Diagram 1600 depicts a recommendation engine 1654 including a food selection engine 1660 and a food score enhancement unit 1662. Recommendation engine 1654 is configured to identify a consumable item, as a healthier alternative, relative to other consumable item having similar characteristics. In some cases, a food item having a relatively higher food score is implied to have a healthier alternative than others similar selections. Recommendation engine 1654 operates to offer a consumable item as a recommended consumable item (e.g., based on, at least on part, its food score) should, for example, a user seeks to consume a prospective meal that includes food items similar to the recommended consumable item.

For example, consider that a user is searching for a breakfast cereal and a number of artificially sweetened cereals having average food scores of 6.6 are selected for presentation. Among the various artificially sweetened cereals are corn flakes frosted with sugar. Recommendation engine 1654 is configured to search for other breakfast cereals that are similar to the searched breakfast cereal (e.g., similar in taste, based on ingredients, consumer reviews, etc.) and present another breakfast cereal that has a higher food score (e.g., 7.2). For example, a food item that includes natural, unsweetened corn flakes, while substantially similar to default food items, can be presented to the user as a healthier choice.

To illustrate operation of recommendation 1654, consider the following example. A user enters a food item 1608 into the search field in an interface 1612 of mobile computing device 1610. In this case, a user is interested in consuming one or more hot dogs as a meal. Data 1640 representing a request for “hot dogs” is received into food selection engine 1660. Food selection engine 1660 determines the characteristics and attributes of a “hot dog,” based, at least in part, from data received from food characteristics database (“DB”) 1602. Food selection engine 1660 determines a subset of food items that substantially share characteristics and/or attributes based on an entered search term “hot dog” 1608. Food selection engine 1660 accesses health-related information, such as a food score, from a food score database (“DB”) 1604 to retrieve food scores for a subset of food items to be presented. Further, food selection engine 1660 generates data 1642 that are configured to display a subset of food items 1620 with accompanying food scores 1609 in interface 1612.

Food score enhancement unit 1662 is configured to detect a request for a food item, such as a hot dog, and is further configured to determine a healthier, but a similar alternative food item. Food score enhancement unit 1662 is configured to extract food characteristics from database 1602 to determine equivalent food items, and is further configured to extract from database 1604 food scores for equivalent food items that may be presented to the user as alternative food choices. In some examples, food score enhancement unit 1662 accesses meal archives database 1606 to detect whether a user has a predilection or dislike for any of the equivalent food items having higher food scores. After filtering out unfavorable equivalent food items, food score enhancement unit 1662 selects one or more alternative food items having enhanced food scores over items 1620. Further, food score enhancement unit 1662 is configured to identify at least one alternative food item for presentation as a food item 1622 via data 1644.

In the example shown in FIG. 16, a request 1608 for a “hot dog” can cause food selection engine 1662 to present food items 1620 directed to a “Hot Dog(s)” with a food score of 7.6, a “Hot Dog with Bun” with a food score of 7.1, and a “Chili Dog and Cheese” with a food score of 6.5. Responsive to the request, food score enhancement unit 1662 can be configured to cause presentation of food item 1622 directed to a “98% fat-free hot dog” with a food score of 8.8. Therefore, recommendation engine 1654 can present to a user a healthier selection that is similar to a request category of food items, whereby a user may be inclined to select a food item with an enhanced food score (e.g., 8.8) relative to other commonly-related food items.

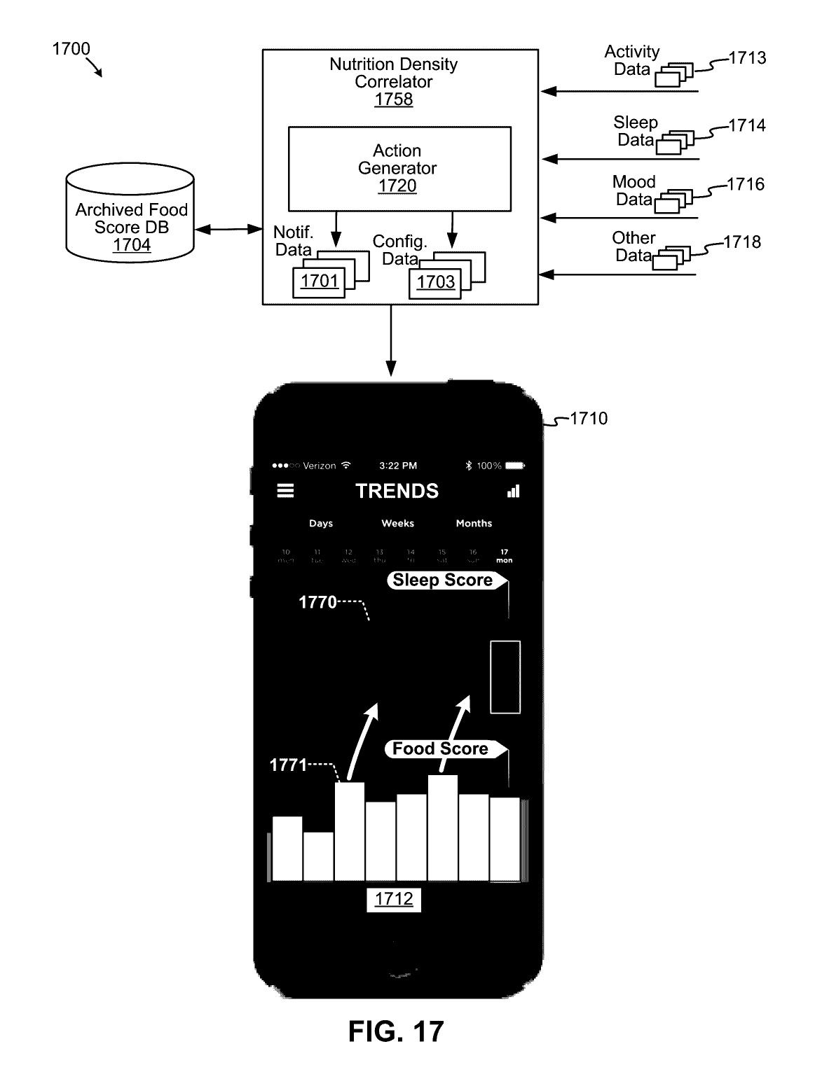

FIG. 17 is a diagram depicting a nutrition density correlator, according to some embodiments. Diagram 1700 includes a nutrition density correlator 1758 configured to correlate food scores to other aspects of a user, including activity, sleep, and mood, to determine trends and to facilitate corrective action responsive to the correlated data. Nutrition density correlator 1758 is configured to receive various amounts of data, such as activity-related data 1713, sleep-related data 1714, mood-related data 1716, and other data 1718 (e.g., biometric data, such as age, gender, weight, height, etc.). Further, nutrition density correlator 1758 can access the repository 1704 including an archived food storage database (DB).

According to some embodiments, nutrition density correlator 1758 is configured to receive food scores in real-time (or near real-time) as well as archived food scores from repository 1704. Further, nutrition density correlator 1758 is configured to analyze data from multiple sources such as activity data 1713, sleep data 1714, and mood data 1760 to determine whether there are any correlations among food scores (e.g., daily food scores) and a user's performance in an activity, such as walking, based on activity data 1713. Nutrition density correlator 1758 is also configured to analyze food score data and sleep data 1714 to determine whether there any correlations. Further, nutrition density correlator 1758 is configured to analyze food score data and mood data 1716 two also determine whether or any correlations.

In view of the foregoing, nutrition density correlator 1758 is configured to derive trend-related data between the food score, as described herein, and a state of a user. As shown in diagram 1700, nutrition density correlator 1758 is configured to determine a correlation between daily food scores and daily sleep scores for presentation in an interface 1712 of mobile computing device 1710. As shown here, relatively high food scores, such as food score 1771, occurs one day prior to a relatively high sleep score 1770. As this occurs more than one time, the user can infer that obtaining a relatively high food score may assist them in meeting their sleep goals as well as any other type of goals.

According to at least one example, nutrition density correlator 1758 includes an action generator 1720, which is configured to generate data representing an action to cause a response to, for example, a correlation between a food score and a score for an activity, for a sleep activity, and the like. In one case, action generator 1720 can generate a notification data 1701 to alert a user of a possible correlation with proposed actions to be taken in view of such a correlation. Further, action generator 1720 can generate configuration data 1703 that is designed to cause a food score determination process to be adapted in a manner responsive to trend data.

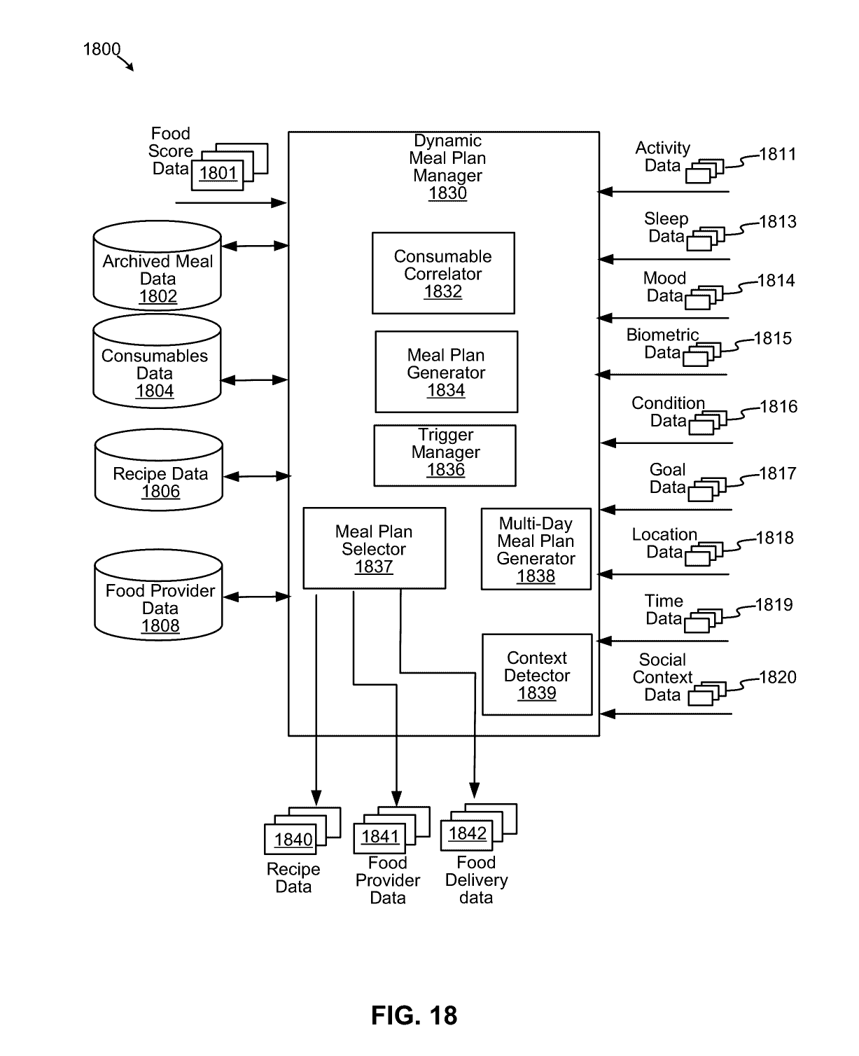

FIG. 18 is a diagram depicting a dynamic meal plan manager, according to some embodiments. Dynamic meal plan manager 1830 of FIG. diagram 1800 is configured to determine a subset of meals that conform to a user's specific state data (e.g., activity level and type, sleep quality and quantity, mood, etc.), condition data, goal data, and context data. According to some embodiments, dynamic meal plan manager 1830 is configured to determine one or more customized meals to recommend to a user based on a user's health and wellness-related goals and activities, including sleep and other exercise-related activities (including walking, running, etc.), one or more past meals consumed by a user based on a health-related goal, etc. Further, dynamic meal plan manager 1830 is configured to adapt one or more customized meals as a function of a user's context. In particular, a subset of meals presented to a user can be modified as a function of a user's location, a time of day, a social context (including identities of one or more persons with which the user is interacting socially), etc. Dynamic meal plan manager 1830 manages a dynamic listing of meals to be presented to a user, whereby the list is configured to the change in real-time (or near real-time) as a function of, among other things, the location of a user, the time of day, and social aspects. Note, too, that the dynamic meal plan manager 1830 can modify a meal plan responsive to any data described in FIG. 18.

Diagram 1800 also depicts several repositories from which dynamic meal plan manager 1830 can receive data for generating various meal plans, especially responsive to various changes in context. As shown, a repository 1802 includes archived meal data for a user. This data describes previously-consumed meals and food items that likely may be acceptable for future consumption by a user. Repository 1804 includes a database of consumable items that describes various aspects of food items and nutritional information. Repository 1806 includes data specifying recipes and constituent ingredients from which a user can prepare meals to achieve various goals, including maintaining weight-loss goals in accordance with a food score. Repository 1808 includes identities of third-party food preparers, such as restaurants, that can deliver food items or prepare a meal for pickup. The nutritional information of the food items and meals and other menu-related items can be viewed by user to determine whether a meal prepared by the third-party prepare can meet an individual's health and wellness goals.

Dynamic meal plan manager 1830 of diagram 1800 is configured to receive food score data 1801 that describes food scores for a number of consumable items, food items, and meals. Dynamic meal plan manager 1830 also is configured to receive various forms of data, including activity data 1811 (e.g., data describing various characteristics of activities including work-related activities, exercise-related activities, or the like). Further, dynamic meal plan manager 1830 is configured to receive sleep data 1813, mood-related data 1814, biometric data 1815 (e.g., age, height, weight, gender, etc.), condition data 1816 (e.g., data describing a health-related condition including, but not limited to, chronic illness, such as diabetes, an allergy, any health-related frailty, such as a calcium deficiency, and the like), goal data 1817 (e.g., data describing various goals, such as a weight-loss goal, a nutritional-related goal, and the like). Diagram 1800 also illustrates that dynamic meal plan manager 1830 also receives context-related data, such as location data 1818 (e.g., data describing at least a user's geographic position and one or more locations at which food may be obtained), time data 1819 (e.g., data describing a time of day, a time duration before and after events, etc.), and social context data 1820 (e.g., data describing the identities of one or more persons with which a user consumes one or more food items, etc.).

Further to FIG. 18, dynamic meal plan manager 1830 can include a consumable correlator 1832, a meal plan generator 1834, a trigger manager 1836, a meal plan selector 1837, a multi-date meal plan generator 1838, and a context detector 1839. Consumable correlator 1832 is configured to correlate food score-related and health-related data to various types of data formed or received from the sources described above. For example, consumable correlator 1832 is configured to extract information regarding the user, such as the users weight-loss goals, the user's condition (e.g., whether a user has a gluten-related allergy, a peanut allergy, an allergy to shellfish, etc.) and the various types of activities in which the user engages, among others.

Based on user-specific data, meal plan generator 1834 is configured to identify a number of various meal plans for a specific user as a function of the specific characteristics of the user, in terms of a condition of health, activity level, etc. Meal plan generator 1834 is configured to generate a number of meals for a user based on the following. For example, meal plan generator 1834 can access data in repository 1808 to determine availability of food at a third-party entity, such as restaurant. Also meal plan generator 1834 can access repository 1806 to receive recipe information (including ingredients) to enable a user to prepare the user's food or meal. Meal plan generator 1834 can access consumable database 1804 to identify the specific food items and nutrient-related information, as well as an accompanying food score.

Meal plan selector 1837 is configured to identify and convey a number of food plans and proposed meals for consumption. For example, meal plan selector 1837 can use at least some of the aforementioned user-specific data to generate data representing meals based on recipe information 1840 (i.e., meals in which a user prepares from scratch), and generate data 1841 representing meals that that can be obtained from proprietor, such as a muffin in a coffee shop. Also, meal data 1842 can be generated to identify a source or origin of food from which to receive a meal via a delivery service.

Context detector 1839 is configured to determine a context (as well as changes in context) of the user based on, for example, location data 1818, time data 1819, and social context data 1820. A change in location, time, and the like, typically causes a user to deviate from a current meal plan. So based on the time of day, and whether a person is at work, traveling out-of-state, at home, or at any other place, context detector 1839 determines such conditions and causes a meal plan to change dynamically in accordance with the context of the user.

Trigger manager 1836 is configured to monitor the various above-described data to match against a number of data files each representing a triggering condition. A data file for a trigger condition includes data representing one or more conditions that, when met, causes trigger manager 1836 to initiate an action, such as selecting a new meal and presenting an updated dynamic list of meals in real-time responsive to a change in the event or condition of the user. An action also can include generating a notification to alert the user of changes in that person's meal plan for the day, for the week, or any other time interval. Trigger manager 1836 is configured to receive data representing meal selections for different meals from meal plan generator 1834 and a context of the user from context detector 1839. Trigger manager 1836 is then configured to trigger a modification in a meal plan based on changes in context and other related data.

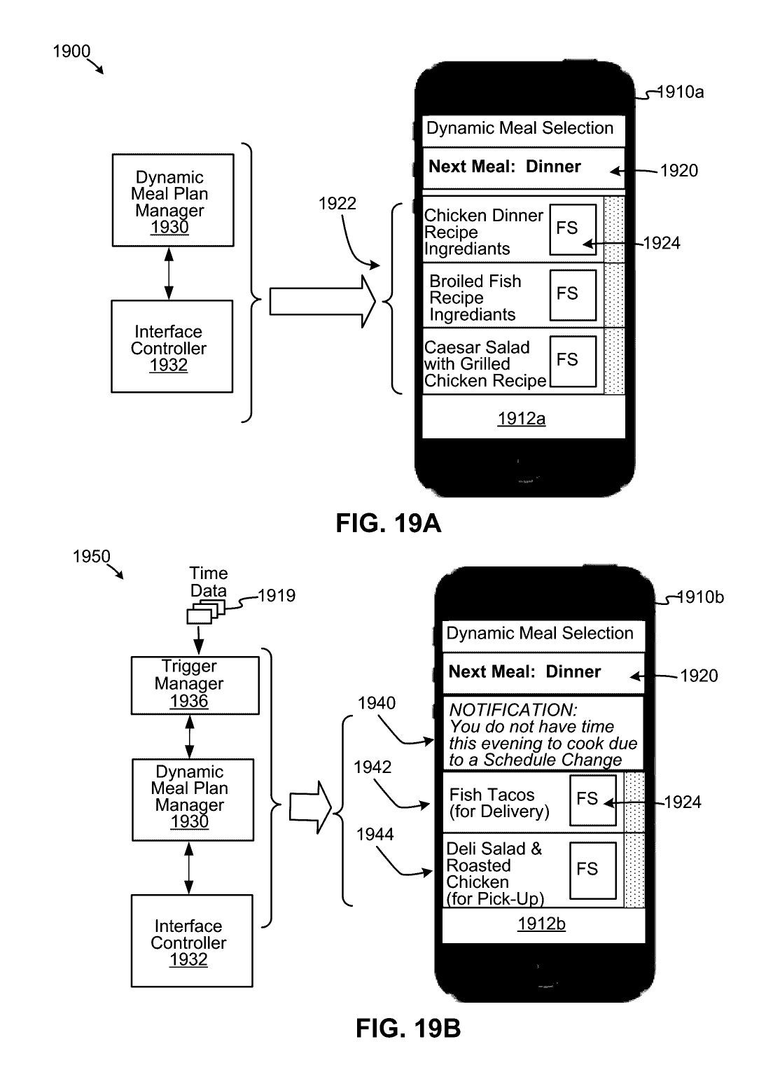

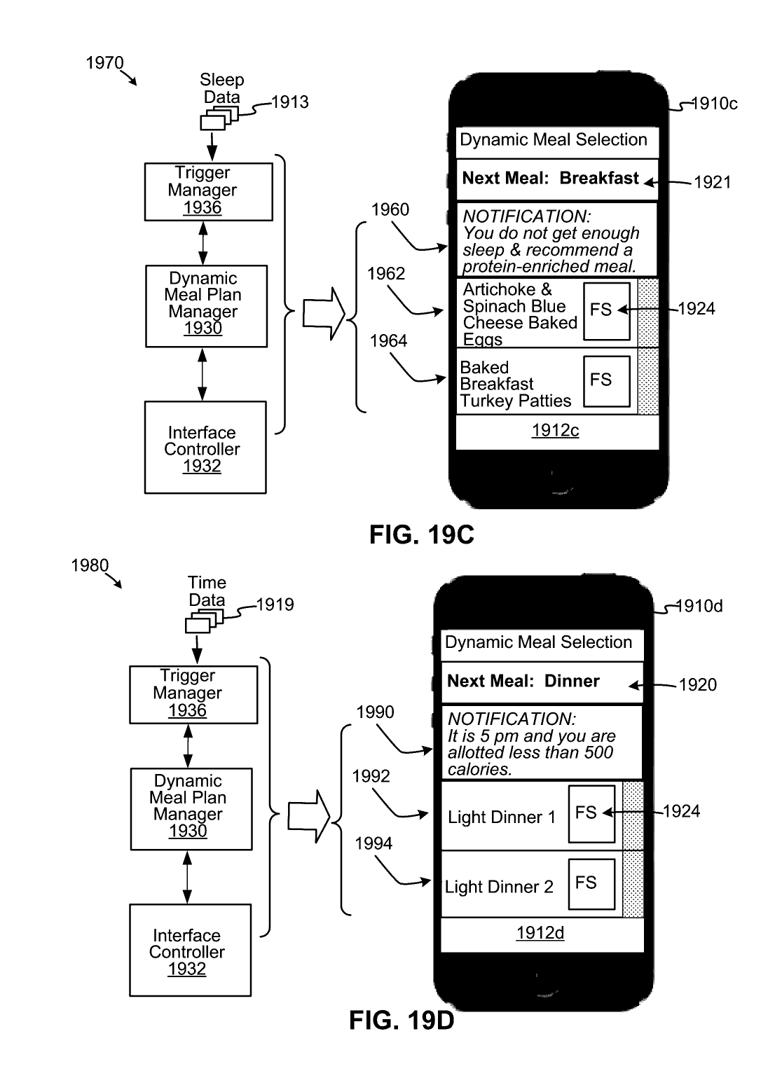

FIGS. 19A to 19D are diagrams depicting examples of operation of a dynamic meal plan manager, according to various embodiments. FIG. 19A is a diagram 1900 that includes a dynamic meal plan manager 1930 interacting with an interface controller 1932 to render a dynamic meal plan at interface 1912a of mobile computing device 1910a. According to the example shown, consider that a user is presented with a meal plan for dinner 1920, the meal plan including items 1922 having associated food scores 1924. In this example, consider that the time is 4 PM and the user is preparing to leave for home from work. Items 1922 each include, when selected, a set of ingredients and recipe for completing a meal at home. Next, consider a modification of the user schedule in the evening, such that the user has no time to prepare a meal in the evening using a recipe.

FIG. 19B is a diagram 1950 that includes a trigger manager 1936, a dynamic meal plan manager 1930, and an interface controller 1932, which cooperate to generate an updated dynamic meal list including items 1942 and 1944 for presentation at interface 1912b on mobile computing device 1910b. A notification 1940 is generated responsive to time-related data 1919 received at trigger manager 1936. In this case, time-related data 1919 indicates that a previously open evening schedule has now been filled by a last-minute request, thereby changing the person's evening schedule that excludes time to prepare a meal from a recipe. As shown, items 1942 in 1944 are prepared meals with corresponding food scores (“FS”) 1924. Given the food score information, a user can adapt his or her evening meal plan without considering the healthiness of each choice.

FIG. 19C is a diagram 1970 includes a trigger manager 1936, a dynamic meal plan manager 1930 and an interface controller 1932, which cooperate to generate an updated dynamic meal list including items 1962 and 1964 for a breakfast meal 1921 at an interface 1912c on a mobile computing device 1910c. A notification 1960 is generated responsive to sleep data 1913 that indicates the user has received less than a threshold amount of sleep (e.g., less than six hours of sleep). Based on sleep data 1913, trigger manager 1936 causes dynamic meal plan manager 1930 to generate recommendations of protein-enriched meals that, for example, may have favorable food scores 1924. Therefore, in this example, a user's breakfast meal plan is dynamically modified based on a trigger related to the state of the user. Similar triggers can be formed based on other activities or conditions of the user.

FIG. 19D is a diagram 1980 that includes a trigger manager 1936, and dynamic meal manager 1930, and an interface controller 1932, which cooperate to generate an updated dynamic meal list including items 1992 and 1994 for a dinner meal 1920 at an interface 1912d on a mobile computing device 1910d. Consider that in this example, the user is eating meals in accordance with a weight-loss goal and has few remaining calories left to consume for the day. Trigger manager 1936 receives time-related data 1919 that specifies that it is 5 PM during the day. A notification 1990 is generated to alert the user of an impending dinner meal and to remind the user that 500 calories or less are allotted for the next meal. Therefore, the user is reminded, and presented with, items for a meal that provide for “light dinner,” such as a salad. Thus, the user is presented with a dynamically changing meal plan customized to meet their health-related goals, with confirmation via food scores 1924.

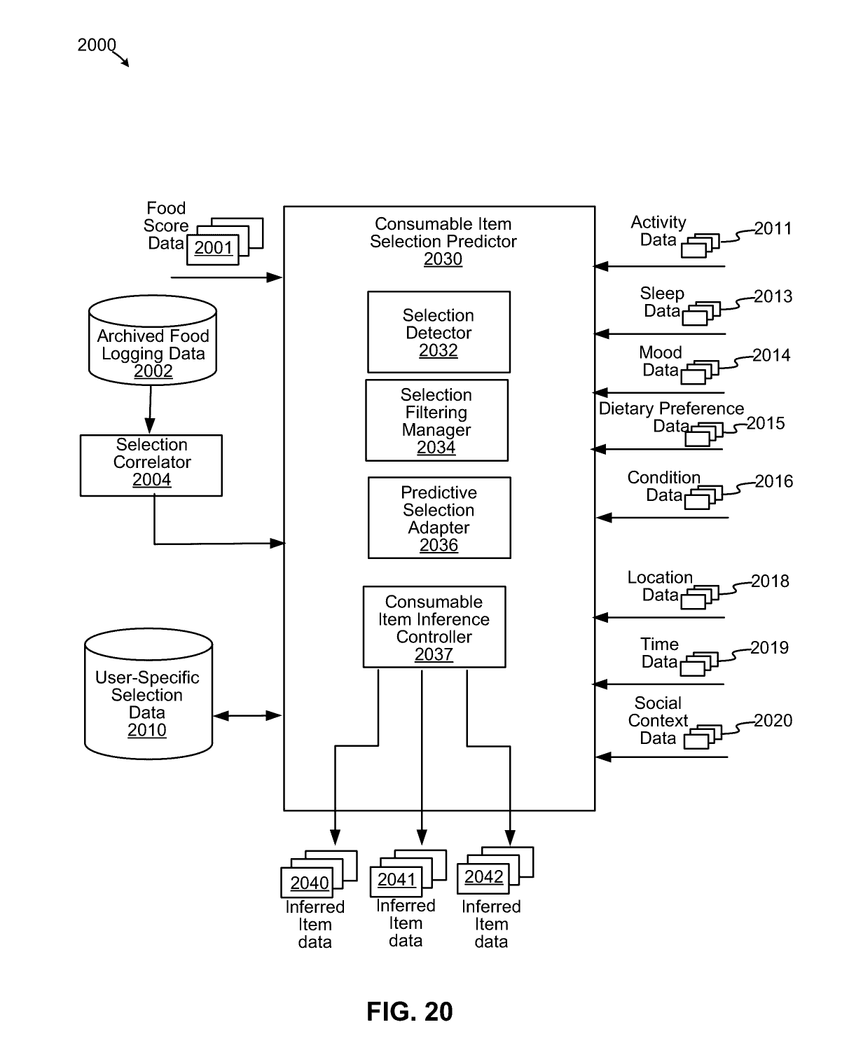

FIG. 20 is a diagram depicting a consumable item selection predictor, according to some embodiments. Diagram 2000 includes a consumable item selection predictor 2030 that is configured to predict a food item for consumption or a next food item (in relation to the first food item) for the purposes of facilitating a meal logging process, according to at least one example. Consumable item selection predictor 2030 includes a selection detector 2032, a selection filtering manager 2034, a predictive selection adapter 2036, and a consumable item inference controller 2037. Further to the example shown, consumable item selection predictor 2030 is configured to receive food score data 2001, activity-related data 2011, sleep-related data 2013, mood-related data 2014, dietary preference data 2015, condition data 2016, location data 2018, time-related data 2019, and social context-related data 2020.

Consumable item selection predictor 2030 can be configured to predict a first food item to present to a user to select for food logging based on an analysis of the above-mentioned data. For example, consider that consumable item selection predictor 2030 can ascertain that a user is beginning a food logging process at a specific time of day, at a specific location, with a specific social context, and in view of the user's activity and condition. In view of this information, consumable item selection predictor 2030 can offer a food item that has a relatively high likelihood of being selected by a user.

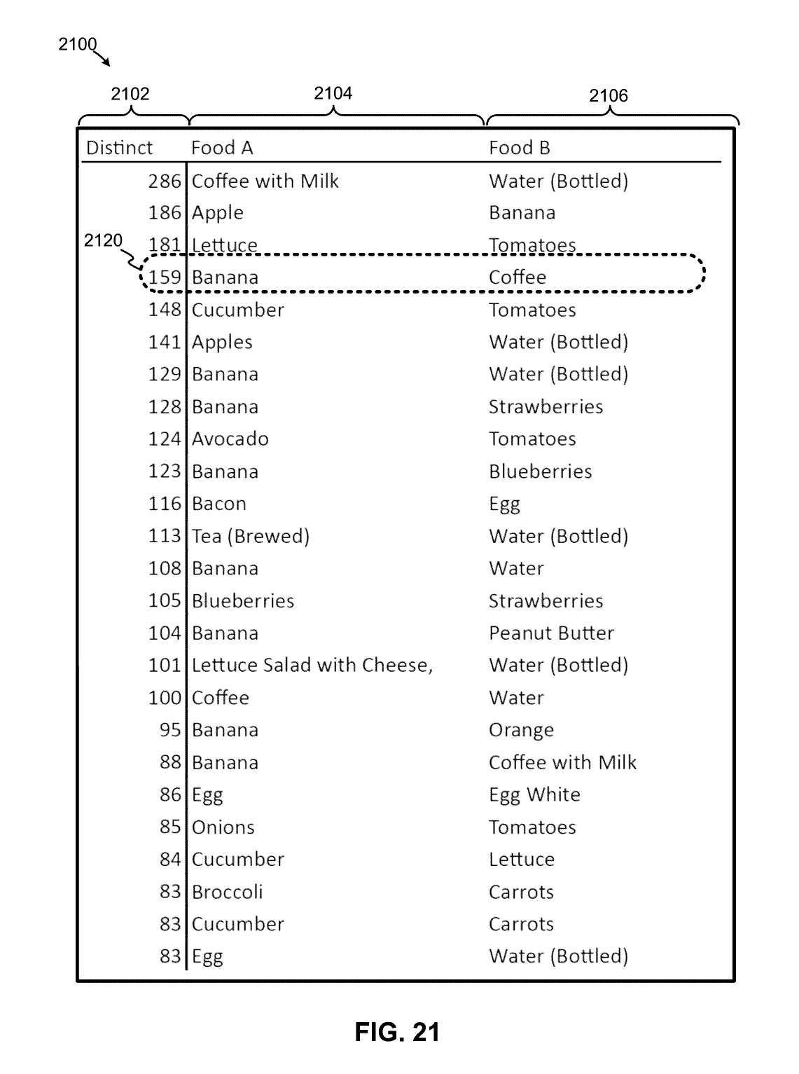

Next, consider an example in which a user has selected a food item. According to some embodiments, selection detector 2032 is configured to detect selection of a food item, and selection filtering manager 2034 is configured to filter through a number of food items to select a subset of food items present to a user. In one case, selection filtering manager 2034 is configured to receive data indicating a likelihood of selection of a second food item based on the selection of the first food item. Archived food logging data 2002 includes a relatively large amount of data describing relationships among food item selected by large number of people. Selection correlator 2004 is configured to correlate the selections and, in some cases, is further configured to generate a probabilistic representation (e.g., a table) for predicting meal completion probabilistically. An example of a probabilistic presentation is depicted in FIG. 21.

FIG. 21 is a diagram of relationships among likely selections of food items, according to some embodiments. Diagram 2100 depicts a ranking of food pairs whereby a first selection 2104 can be paired with a second selection 2106. In some cases, the selection of one food item may predict the selection of a second food item. As shown, pairs of food selections are also associated with a number 2102 that indicates distinct occurrences, as provided by selection correlator 2004 of FIG. 20. Referring to FIG. 21, food pair 2120 describes a selection of a “banana” and a selection of “coffee,” with a number of 159 distinct occurrences. Note that the number of distinct occurrences can also determine a probability. So, in view of the foregoing, the selection of a banana indicates a relatively high likelihood that the next selection may be a cup of coffee. Note that while FIG. 21 illustrates a number of statistically-related pairs, the various embodiments are not so limited to the use of bigrams. Rather, the various embodiments can also include relationships, such as trigrams, or any number of related items.

Referring back to FIG. 20, selection filtering manager 2034 is configured to identify relationships, such as those depicted in FIG. 21, for purposes of determining the likelihood of the next selection. Selection filtering manager 2034 also analyzes other data, such as activity data 2011 through to social context data 2020, to determine a subset of next food items likely to be selected by user. Predictive selection adapter 2034 is configured to monitor the user's first selection and second selection, and over time, determine a user's preference such that the probabilities of selecting one food item in view of another food item is adapted to conform to a user's preference. Predictive selection adapter 2034 can store the user specific selection data in repository 2010 for future use.

Consumable item inference controller 2037 is configured to receive data representing likely food items that may be selected after the selection of a first item. In response, consumable item inference controller 2037 is configured to generate inferred items 2040, 2041, 2042. For example, if the user selects coffee as a first item of food to be logged, consumable item inference controller 2037 can generate inferred items 2040, 2041, and 2042, to represent likely second selections of sugar, cream, and nonfat milk, respectively.

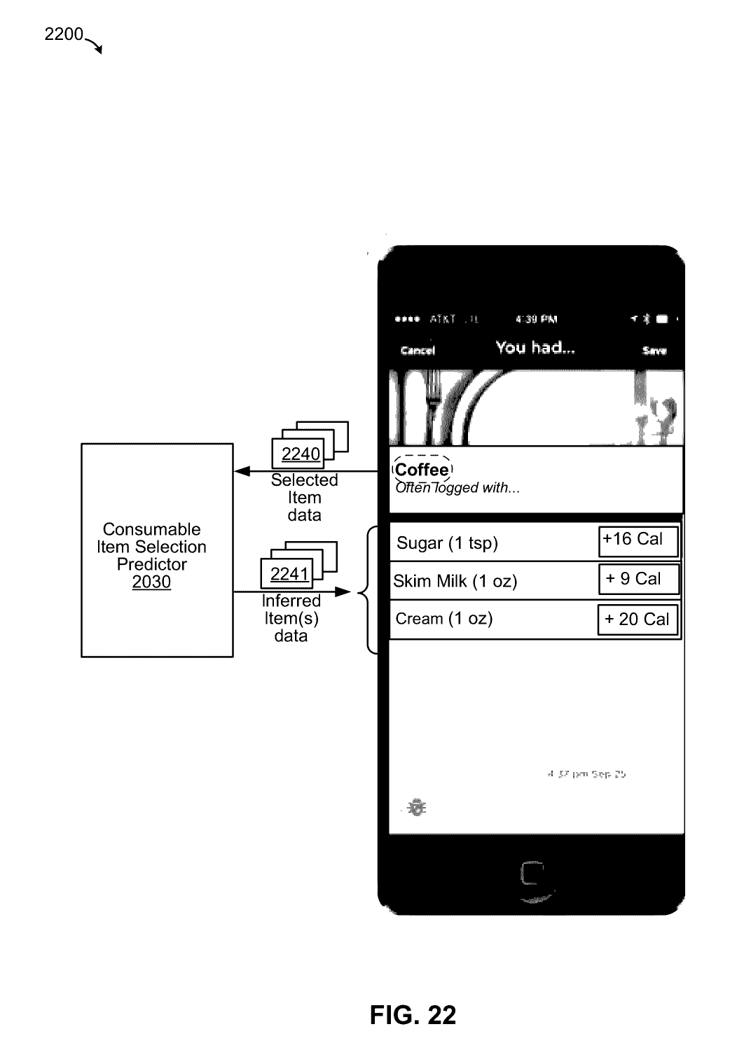

FIG. 22 is a diagram depicting presentation of inferred food items for food logging, according to some embodiments. Diagram 2200 includes a consumable item selection predictor 2030 is configured to receive data 2240 representing a selected food item, such as coffee. Consumable item selection predictor 2030 determines a subset of likely next food items that a user may select in view of the first food item. As such, consumable item selection predictor 2030 presents inferred items 2241 to the user so that a user need not manually request or search for such items. Therefore, consumable item selection predictor 2030 assists in facilitating an expedited food logging flow that can reduce manual intervention (e.g., manual searches for other food items).

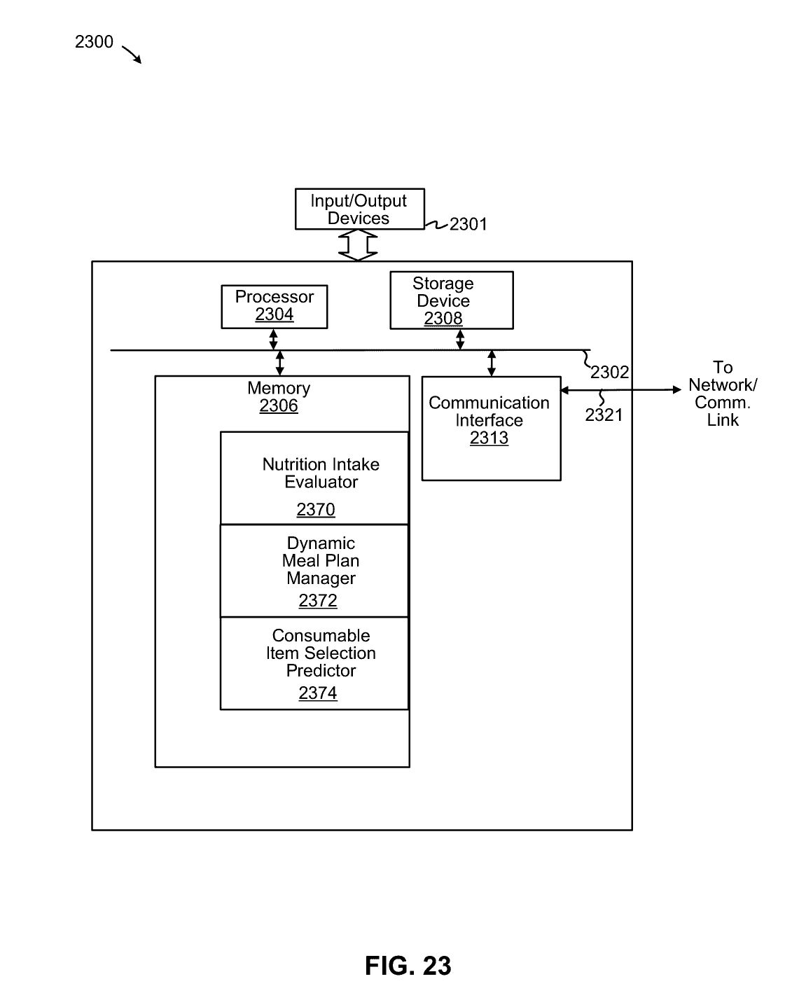

FIG. 23 illustrates an exemplary computing platform disposed in a device configured to provide food-related tracking in accordance with various embodiments. In some examples, computing platform 2300 may be used to implement computer programs, applications, methods, processes, algorithms, or other software to perform the above-described techniques.

In some cases, computing platform can be disposed in wearable device or implement, a mobile computing device, or any other device.

Computing platform 2300 includes a bus 2302 or other communication mechanism for communicating information, which interconnects subsystems and devices, such as processor 2304, system memory 2306 (e.g., RAM, etc.), storage device 23012 (e.g., ROM, etc.), a communication interface 2313 (e.g., an Ethernet or wireless controller, a Bluetooth controller, etc.) to facilitate communications via a port on communication link 2321 to communicate, for example, with a computing device, including mobile computing and/or communication devices with processors. Processor 2304 can be implemented with one or more central processing units (“CPUs”), such as those manufactured by Intel® Corporation, or one or more virtual processors, as well as any combination of CPUs and virtual processors. Computing platform 2300 exchanges data representing inputs and outputs via input-and-output devices 2301, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 2300 performs specific operations by processor 2304 executing one or more sequences of one or more instructions stored in system memory 2306, and computing platform 2300 can be implemented in a client-server arrangement, peer-to-peer arrangement, or as any mobile computing device, including smart phones and the like. Such instructions or data may be read into system memory 2306 from another computer readable medium, such as storage device 2308. In some examples, hard-wired circuitry may be used in place of or in combination with software instructions for implementation. Instructions may be embedded in software or firmware. The term “computer readable medium” refers to any tangible medium that participates in providing instructions to processor 2304 for execution. Such a medium may take many forms, including but not limited to, non-volatile media and volatile media. Non-volatile media includes, for example, optical or magnetic disks and the like. Volatile media includes dynamic memory, such as system memory 2306.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 2302 for transmitting a computer data signal.

In some examples, execution of the sequences of instructions may be performed by computing platform 2300. According to some examples, computing platform 2300 can be coupled by communication link 2321 (e.g., a wired network, such as LAN, PSTN, or any wireless network) to any other processor to perform the sequence of instructions in coordination with (or asynchronous to) one another. Computing platform 2300 may transmit and receive messages, data, and instructions, including program code (e.g., application code) through communication link 2321 and communication interface 2313. Received program code may be executed by processor 2304 as it is received, and/or stored in memory 2306 or other non-volatile storage for later execution.

In the example shown, system memory 2306 can include various modules that include executable instructions to implement functionalities described herein. In the example shown, system memory 2306 includes a nutrition intake evaluator 2370, a dynamic meal plan manager 2372, and a consumable item selection predictor 2374, one or more of which can be configured to provide or consume outputs to implement one or more functions described herein.

In at least some examples, the structures and/or functions of any of the above-described features can be implemented in software, hardware, firmware, circuitry, or a combination thereof. Note that the structures and constituent elements above, as well as their functionality, may be aggregated with one or more other structures or elements. Alternatively, the elements and their functionality may be subdivided into constituent sub-elements, if any. As software, the above-described techniques may be implemented using various types of programming or formatting languages, frameworks, syntax, applications, protocols, objects, or techniques. As hardware and/or firmware, the above-described techniques may be implemented using various types of programming or integrated circuit design languages, including hardware description languages, such as any register transfer language (“RTL”) configured to design field-programmable gate arrays (“FPGAs”), application-specific integrated circuits (“ASICs”), or any other type of integrated circuit. According to some embodiments, the term “module” can refer, for example, to an algorithm or a portion thereof, and/or logic implemented in either hardware circuitry or software, or a combination thereof. These can be varied and are not limited to the examples or descriptions provided.

In some embodiments, a nutrition intake evaluator or one or more of its components (or a dynamic meal plan manager or a consumable item selection predictor), or any process or device described herein, can be in communication (e.g., wired or wirelessly) with a mobile device, such as a mobile phone or computing device, or can be disposed therein. In some cases, a mobile device, or any networked computing device (not shown) in communication with a nutrition intake evaluator (or a dynamic meal plan manager or a consumable item selection predictor) or one or more of its components (or any process or device described herein), can provide at least some of the structures and/or functions of any of the features described herein. As depicted in FIG. 1 and/or subsequent figures, the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in any of the figure can represent one or more algorithms. Or, at least one of the elements can represent a portion of logic including a portion of hardware configured to provide constituent structures and/or functionalities.

For example, a nutrition intake evaluator (or a dynamic meal plan manager or a consumable item selection predictor), any of its one or more components, or any process or device described herein, can be implemented in one or more computing devices (i.e., any mobile computing device, such as a wearable device, an audio device (such as headphones or a headset) or mobile phone, whether worn or carried) that include one or more processors configured to execute one or more algorithms in memory. Thus, at least some of the elements in FIG. 1 (or any subsequent figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, a nutrition intake evaluator (or a dynamic meal plan manager or a consumable item selection predictor), including one or more components, or any process or device described herein, can be implemented in one or more computing devices that include one or more circuits. Thus, at least one of the elements in FIG. 1 (or any subsequent figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
identifying data representing nutritional content of one or more consumables;
selecting data representing a first element of the one or more consumables;
identifying the first element as a first nutrient;
identifying a second element of the one or more consumables;
characterizing an association between the first nutrient and the second element; and
determining data representing an indicator indicative of a nutrient density of at least the first element included in the one or more consumables.

2. The method of claim 1, further comprising:
identifying the second element as a second nutrient.

3. The method of claim 1, further comprising:
identifying the second element as a consumable characteristic.

4. The method of claim 1, further comprising:
identifying one or more other nutrients and one or more other elements; and
characterizing a plurality of associations between at least one other nutrient in a subset of the one or more other nutrients and at least one other element in a subset of the one or more other element,

5. The method of claim 4, wherein determining data representing the indicator comprises:
determining the indicator based on a value of the association and other values for the plurality of associations.

6. The method of claim 6, further comprising:
applying a weighting factor to one or more of the value of the association and the plurality of associations.

7. The method of claim 1, further comprising:
identifying data representing another consumable, which is similar to at least one of the one or more consumables and is associated with another indicator having a value greater than the indicator; and
generating data representing a recommendation associated with the another consumable; and
transmitting a signal to cause presentation of the recommendation and an interface.

8. The method of claim 1, further comprising:
identifying different indicators including the indicator over multiple units of time;
correlating the different indicators against other data that includes one or more of activity data, sleep data, and mood data; and
determining a trend based on a correlation between the different indicators and the other data.

9. A method comprising:
receiving archived meal data including characteristics of previously-consumed meals;
receiving data including characteristics of consumables;
correlating one or more of state data representing a state, condition data representing a health-related condition, and goal data representing a health-related goal to one or more characteristics of consumables constituting a meal;
generating data representing one or more meal plans based on a correlation of one or more of the state data, the condition data, and the goal data and the one or more characteristics of consumables;
determining a context;
modifying the one or more meal plans based on the context to form at least a modified meal plan;
generating a signal to cause presentation of the modified meal plan and an interface.

10. The method of claim 9, wherein determining the context comprises:
one or more of a location, a time, and identities of persons.

11. The method of claim 9, further comprising:
detecting an event constituting a trigger; and
generating a notification associated with the modified meal plan.

12. The method of claim 9, further comprising:
forming compressed representations of the consumables, each of the representations including data independent of amounts of each consumable; and
formatting presentation data for a user interface, the presentation data representing nutritional content of one or more consumables to be displayed as a portion of the modified meal plan.

13. A method comprising:
receiving data representing correlated selections within sets of a consumable item and one or more other consumable items;
detecting selection of the consumable item to form a selected consumable item;
identifying a subset of the one or more other consumable items from the sets that are correlated to the selected consumable item;
predicting selection of the one or more other consumable items to form a predicted consumable item; and
generating a signal to cause presentation of the predicted consumable item.

14. The method of claim 13, further comprising:
determining data including one or more state data, condition data, and context data; and
adapting probabilities associated with the correlated selections within the sets responsive to the data.

15. The method of claim 13, further comprising:
determining indicators as compressed representations of nutrients for the selected consumable item and a next predicted consumable item;
determining the indication for the next predicted consumable item has a greater value than the selected consumable item and
selecting the next predicted consumable item for presentation based on the greater value.
